(19) United States
(12) Patent Application Publication
(10) Pub. No.: US 2008/0212774 A1
(43) Pub. Date: Sep. 4, 2008

(54) Device for and a Method of Processing an Encrypted Data Stream in a Cryptographic System

(75) Inventors: Eric Moors, Someren (NL); Roland Manders, Horst (NL); Albert Rijckaert, Waalre (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/912,320

(22) PCT Filed: Apr. 25, 2006
(86) PCT No.: PCT/IB06/51278

§ 371 Date: Oct. 23, 2007

(30) Foreign Application Priority Data
Apr. 26, 2005 (EP) 05103394.2

(51) Int. Cl. H04N 7/167; H04L 9/00

(52) U.S. Cl. 380/201; 380/42

(57) ABSTRACT

A device (3200) for processing an encrypted data stream (3201) in a cryptographic system, in which decryption data (3204) are provided for decrypting each segment (3202) of the encrypted data stream (3201) for reproduction of the decrypted data stream, wherein the device (3200) comprises a first determining unit (3209) for determining, in case of switching from a first reproduction mode (1501) of reproducing the data stream (3201) to a second reproduction mode (1502) of reproducing the data stream (3201), a current position of reproduction within the data stream, and a second determining unit (3210) for determining a starting position for starting reproduction in the second reproduction mode (1502) based on the determined current position.

### FIELD OF THE INVENTION

The invention relates to a device for processing an encrypted data stream in a cryptographic system.

Beyond this, the invention relates to a method of processing an encrypted data stream in a cryptographic system.

Moreover, the invention relates to a program element.

Furthermore, the invention relates to a computer-readable medium.

### BACKGROUND OF THE INVENTION

Electronic entertainment devices become more and more important. Particularly, an increasing number of users buy hard disk based audio/video players and other entertainment equipment.

Since the reduction of storage space is an important issue in the field of audio/video players, audio and video data are often stored in a compressed manner, and for security reasons in an encrypted manner.

MPEG2 is a standard for the generic coding of moving pictures and associated audio and creates a video stream out of frame data that can be arranged in a specified order called the GOP (“Group Of Pictures”) structure. An MPEG2 video bitstream is made up of a series of data frames encoding pictures. The three ways of encoding a picture are intra-coded (I picture), forward predictive (P picture) and bidirectional predictive (B picture). An intra-coded frame (I-frame) is related to a particular picture and contains the corresponding data. A forward predictive frame (P-frame) needs information of a preceding I-frame or P-frame. A bidirectional predictive frame (B-frame) is dependent on information of a preceding or subsequent I-frame or P-frame.

It is an interesting function in a media playback device to switch from a normal reproduction mode, in which media content is played back in a normal speed, to a trick-play reproduction mode, in which media content is played back in a modified manner, for instance with an increased speed (“fast forward”).

WO 2004/071091 A1 discloses generation of encrypted video information with an encrypted stream of video information containing first video frames and second video frames which are accessible and non-accessible during trick-play respectively. From a source stream encrypted, that is to say for decryption of repeatedly changing control words, sections of the stream are identified where respective first ones of the frames occur in the stream. Control words for decryption are included in the stream. At least part of the control words are included in the stream at positions selected synchronized to the identified sections.

For switching from a normal reproduction mode to a trick-play reproduction mode, it is desired that the transition between the two modes is realized without a deterioration of the reproduction quality.

### OBJECT AND SUMMARY OF THE INVENTION

It is an object of the invention to switch from one reproduction mode to another reproduction mode in an efficient manner.

In order to achieve the object defined above, a device for processing an encrypted data stream in a cryptographic system, a method of processing an encrypted data stream in a cryptographic system, a program element and a computer-readable medium according to the independent claims are provided.

According to an exemplary embodiment of the invention, a device for processing an encrypted data stream in a cryptographic system is provided, in which decryption data are provided for decrypting each segment of the encrypted data stream for reproduction of the decrypted data stream. The device may comprise a first determining unit for determining, in case of switching from a first reproduction mode of reproducing the data stream to a second reproduction mode of reproducing the data stream, a current position of reproduction within the data stream, and a second determining unit for determining a starting position for starting reproduction in the second reproduction mode based on the determined current position.

According to another exemplary embodiment of the invention, a method of processing an encrypted data stream in a cryptographic system is provided, in which decryption data are provided for decrypting each segment of the encrypted data stream for reproduction of the decrypted data stream. The method comprises the steps of, in case of switching from a first reproduction mode of reproducing the data stream to a second reproduction mode of reproducing the data stream, determining a current position of reproduction within the data stream, and determining a starting position for starting reproduction in the second reproduction mode based on the determined current position.

Beyond this, according to another exemplary embodiment of the invention, a computer-readable medium is provided, in which a computer program of processing an encrypted data stream in a cryptographic system, in which decryption data are provided for decrypting each segment of the encrypted data stream for reproduction of the decrypted data stream, is stored, which computer program, when being executed by a processor, is adapted to control or carry out the above-mentioned method steps.

Moreover, according to still another exemplary embodiment of the invention, a program element of processing an encrypted data stream in a cryptographic system is provided, in which decryption data are provided for decrypting each segment of the encrypted data stream for reproduction of the decrypted data stream, which program element, when being executed by a processor, is adapted to control or carry out the above-mentioned method steps.

Processing encrypted data according to the invention can be realized by a computer program, that is to say by software, or by using one or more special electronic optimization circuits, that is to say in hardware, or in hybrid form, that is to say by means of software components and hardware components.

The characterizing features according to the invention particularly have the advantage that a switching from a first reproduction mode (for instance a normal play mode) of reproducing an encrypted data stream to a second reproduction mode (for instance a trick-play mode) is realized in a very efficient manner and without a significant deterioration of the quality of the reproduced data. To achieve this, the current reproduction position in the first reproduction mode is determined, and the starting position for starting a reproduction in the second reproduction mode is adjusted based on this position knowledge.

In a particular scenario of a reproduction system for an encrypted data stream being divided into a plurality of succeeding segments, decryption of each segment is necessary before the respective data may be actually reproduced. Since it may take some time for providing decryption data for a succeeding segment, the current position of reproduction within the currently reproduced segment should be taken into account when determining a position at which the reproduction in the new second reproduction mode shall start.

Generally, a jump target in switching from a first operation mode (for instance a normal reproduction mode) to a second reproduction mode (for instance a trick-play reproduction mode) can be chosen advantageously according to the invention or can even be optimized by taking into account the current position of reproduction within the currently replayed segment. For instance, the time left for playing back the currently reproduced segment to the end compared to the time needed for receiving decryption data (for instance a control word) for decrypting the subsequent segment of encrypted data is an appropriate criteria to decide when it is a good time to actually switch from the first reproduction mode to the second reproduction mode.

At a transition from a normal play to a trick-play, an earliest possible transition time may be calculated in such a manner that the time left to the moment of switching is still sufficient for decoding the subsequently reproduced data.

According to an exemplary embodiment of the invention, a method for optimizing the jump target when switching between normal play and trick-play in digital video systems is provided. This method can be realized in the frame of the MPEG2 standard. Successive control words, which may be supplied in units, may be required for decrypting segments of video. When switching between normal play and trick-play, the current position may be determined, as well as a starting position for trick-play processing based on the trick-play speed which may be selected by a user. This starting position should be such that an ECM (entitlement control message) of a next or previous period is decrypted before this period is actually entered. If the last normal-play position is within the allowed range then that position may be used as a jump target. If it is not, a position as close to it as possible may be chosen for actually switching from normal play to trick-play.

According to one aspect of the invention, a trick-play generator is provided decrypting a stream in order to select plaintext I-frames and construct a trick-play stream from it. The decryption process may start as soon as possible after switching to the trick-play mode.

According to an aspect of the invention, trick-play processing of a video stream or an audio stream may be performed.

The system according to the invention may improve the velocity of the switching performance, may realize such a switching performance in an efficient manner, and may achieve a proper quality of reproduced data even at a transition point between a first reproduction mode and a second reproduction mode.

Exemplary fields of applying the system according to the invention are digital video recording devices, such as hard disk combinations, DVD+RW devices, etc.

According to one aspect of the invention, a system is provided to create efficiently trick-play on an encrypted stream. Thus, a balanced system may be provided that allows easy forward and reverse trick-play on a recorded stream. According to the invention, the maximally achievable trick-play speed can be very large, because a proper switching point is estimated in the stream to start the trick-play by taking into consideration properties of the digital video broadcasting cryptographic system.

When a user presses a corresponding button or provides the system in another manner with the command that she or he intends to switch from a normal play mode to a trick-play mode, it is usually desired that a transition occurs as fast as possible. On the other hand, the transition should go hand in hand with a proper reproduction quality. When such a transition occurs, an overlap of data reproduced before and after switching should be as small as possible, and there should also be no significant gap of reproduction. Thus, the switching of normal reproduction to trick-play reproduction has to be synchronized considering a delay time needed by a smartcard to decrypt data generating control words as decryption information.

Referring to the dependent claims, further exemplary embodiments of the invention will be described.

Next, exemplary embodiments of the device for processing an encrypted data stream in a cryptographic system will be described. These embodiments may also be applied for the method of processing an encrypted data stream in a cryptographic system, for the computer-readable medium and for the program element.

In the device according to the invention, the second determining unit may be adapted for determining a starting position for starting reproduction in the second reproduction mode based on the (cryptographic) characteristics of the cryptographic system. When switching from a normal play mode to a trick-play mode or vice versa, it should be taken into account that the cryptographic system may continuously require decryption information for decrypting encrypted data. Since this decryption may take some time or since the provision of such decryption information may be delayed, this characteristic is an appropriate criteria for determining at which time a desired switch from a first reproduction mode to a second reproduction mode may actually be carried out.

Particularly, the second determining unit may be adapted for determining a starting position for starting reproduction in the second reproduction mode based on a delay with which decryption data are provided in the cryptographic system. For instance, when encrypted media content is transmitted in the frame of an MPEG2 standard, subsequent segments of the encrypted data are decrypted with so-called control words as decrypting information which control words may be generated in a smartcard based on previously transmitted ECMs (entitlement control message). Since the smartcard may need some processing time for generating control words, the corresponding data of a succeeding segment can only be reproduced (in the frame of a trick-play mode) after the decryption. Taking into account such a delay for judging a proper starting position for the trick-play mode allows starting trick-play without a long interruption time between normal play mode and trick-play mode.

The second determining unit may be adapted for determining a starting position for starting reproduction in the second reproduction mode based on a delay with which decryption data for decrypting a succeeding segment are provided in the cryptographic system. Referring to the foregoing explanation, such a control word generation time can be of importance when a proper time of transition to a modified reproduction mode, for instance a trick-play mode, is determined.

The second determining unit may be adapted for determining a beginning or an end of a segment preceding or succeeding the currently reproduced segment as a starting position for starting reproduction of the second reproduction mode. For instance, in the case of a fast forward trick-play mode, the system may simply go back, when switching to the trick-play mode, to the starting position of the actually replayed segment. This means that a part of the data of the currently replayed data segment is replayed twice, namely beforehand in the normal play mode and subsequently in the trick-play mode. However, this scheme is very easy and secure and can be realized with low computational burden. In a similar manner, in a fast reverse trick-play mode, the system may simply jump to the end of a currently reproduced segment.

Particularly, the second determining unit may be adapted to determine the starting position based on a speed of reproduction of the data stream according to the second reproduction mode. This speed (for example two times, three times or four times of a normal replay speed), optionally in combination with the delay time and/or the remaining time of a currently reproduced segment is a further important criteria for determining when switching from the first reproduction mode to the second reproduction mode is appropriate.

The second determining unit may be adapted to determine the starting position in a manner that a segment of the encrypted data which is to be reproduced next after a currently reproduced segment of the data stream is decryptable by means of the corresponding decryption data decrypted at a time before the reproduction of the currently reproduced segment of the data stream is finished. This criterion allows avoiding waiting times between a normal play mode and a trick-play mode that can occur since the data have to be decoded. In other words, only when the decryption data needed for decrypting the content of a subsequent segment are readily decrypted before the end of the segment (which takes some time due to the latency of a decrypting smartcard), it will be possible to continue reproduction without an interruption.

The device according to the invention may be adapted to process a data stream of video data or audio data. However, such media content is not the only type of data that may be processed with the scheme according to the invention. Trick-play generation and similar applications are an issue for both, video processing and (pure) audio processing.

The device according to the invention may be adapted to process a data stream of digital data.

Particularly, the first reproduction mode may be a normal reproduction mode. The term “normal reproduction mode” particularly denotes a reproduction mode in which data related to the segments of the data stream are reproduced or replayed in a manner that all the data transmitted are used. The velocity of reproducing the data is not modified with respect to the sequence of data as transmitted.

Further, the device may be adapted in such a manner that the second reproduction mode is a trick-play reproduction mode. A user may adjust such a “trick-play mode” by selecting corresponding options/commands in a user interface, for instance buttons of a device, a keypad, or a remote control. The trick-play reproduction mode selected by the user (which may be based on information concerning the position of I-frames in the data stream) may be one of the group consisting of a fast forward reproduction mode, a fast reverse reproduction mode, a slow motion reproduction mode, a freeze frame reproduction mode, an instant replay reproduction mode, and a reverse reproduction mode. Other trick-play schemes, however, are possible. For trick-play, usually only a part of data shall be used for output (for instance for visual display and/or for acoustical output). Since not all data (P-frames, B-frames) in a data stream can be used independently from other frames (I-frames) for generating these reproducible signals, the knowledge of the independently usable data (I-frames) may be particularly desired.

The device according to the invention may comprise a generation unit adapted to generate a decrypted data stream or an encrypted data stream for reproduction in the second reproduction mode from the starting point onwards. Such a generation unit may provide the data in a manner as to be outputable directly, and may for instance comprise a display device and/or an acoustical output device.

The device according to the invention may be adapted to process an encrypted MPEG2 data stream. MPEG2 is the designation for a group of audio and video coding standards agreed upon by MPEG (moving pictures expert group), and published as the ISO/IEC13818 international standard. MPEG2 may be used to encode audio and video for broadcast signals, including digital satellite and cable TV, but may also be used for DVD. In the frame of the invention, trick-play switching is enabled in an efficient manner for an MPEG2 encoded data stream.

The device according to the invention may be realized as at least one of the group consisting of a digital video recording device, a network-enabled device, a conditional access system, a portable audio player, a portable video player, a mobile phone, a DVD player, a CD player, a hard disk-based media player, an internet radio device, a public entertainment device, and an MP3 player. However, these applications are only exemplary.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a time-stamped transport stream packet.

FIG. 2 shows an MPEG2 group of picture structure with intra-coded frames and forward predictive frames.

FIG. 3 illustrates an MPEG2 group of picture structure with intra-coded frames, forward predictive frames and bidirectional predictive frames.

FIG. 4 illustrates a structure of an characteristic point information file and stored stream content.

FIG. 5 illustrates a system for trick-play on a plaintext stream.

FIG. 6 illustrates time compression in trick-play.

FIG. 7 illustrates trick-play with fractional distance.

FIG. 8 illustrates low speed trick-play.

FIG. 9 illustrates a general conditional access system structure.

FIG. 10 illustrates a digital video broadcasting encrypted transport stream packet.

FIG. 11 illustrates a transport stream packet header of the digital video broadcasting encrypted transport stream packet of FIG. 10.

FIG. 12 illustrates a system allowing performing trick-play on a fully encrypted stream.

FIG. 13 illustrates a full transport stream and a partial transport stream.

FIG. 14 illustrates a trick-play generator and receiver according to an exemplary embodiment of the invention.

FIG. 15 illustrates switching to forward trick-play in the frame of a blind switching scheme.

FIG. 16 illustrates generalized switching to forward trick-play in the frame of a blind switching scheme.

FIG. 17 illustrates incorrect switching to reverse trick-play in the frame of a blind switching scheme.

FIG. 18 illustrates generalized switching to reverse trick-play in the frame of a blind switching scheme.

FIG. 19 illustrates fast switching to forward trick-play for a stream type I in the frame of a fast switching scheme.

FIG. 20 illustrates fast switching to forward trick-play for a stream type II in the frame of a fast switching scheme.

FIG. 21 illustrates fast switching to forward trick-play for a stream type II near the end of the current cryptographic period in the frame of a fast switching scheme.

FIG. 22 illustrates fast switching to reverse trick-play for a stream type I in the frame of a fast switching scheme.

FIG. 23 illustrates fast switching to reverse trick-play for a stream type II in the frame of a fast switching scheme.

FIG. 24 illustrates fast switching to reverse trick-play for a stream type II near the end of the current cryptographic period in the frame of a fast switching scheme.

FIG. 25 illustrates improved switching to reverse trick-play for a stream type II near the end of the current cryptographic period in the frame of a fast switching scheme.

FIG. 26 illustrates generalized fast switching to trick-play in the frame of a fast switching scheme.

FIG. 27A illustrates a first scheme for jump target optimization according to an exemplary embodiment of the invention.

FIG. 27B illustrates a second scheme for jump target optimization according to an exemplary embodiment of the invention.

FIG. 27C illustrates a third scheme for illustrating jump target optimization according to an exemplary embodiment of the invention.

FIG. 28 shows a start region for forward trick-play in the frame of a jump optimization scheme.

FIG. 29 illustrates a start region for reverse trick-play in the frame of a jump optimization scheme.

FIG. 30 illustrates a trick-play generator and receiver in a configuration for a hybrid stream according to an exemplary embodiment of the invention.

FIG. 31 illustrates switching from normal play to trick-play for a hybrid stream.

FIG. 32 illustrates a device for processing an encrypted data stream in a cryptographic system according to an exemplary embodiment of the invention.

### DESCRIPTION OF EMBODIMENTS

The illustration in the drawing is schematically. In different drawings, similar or identical elements are provided with the same reference signs.

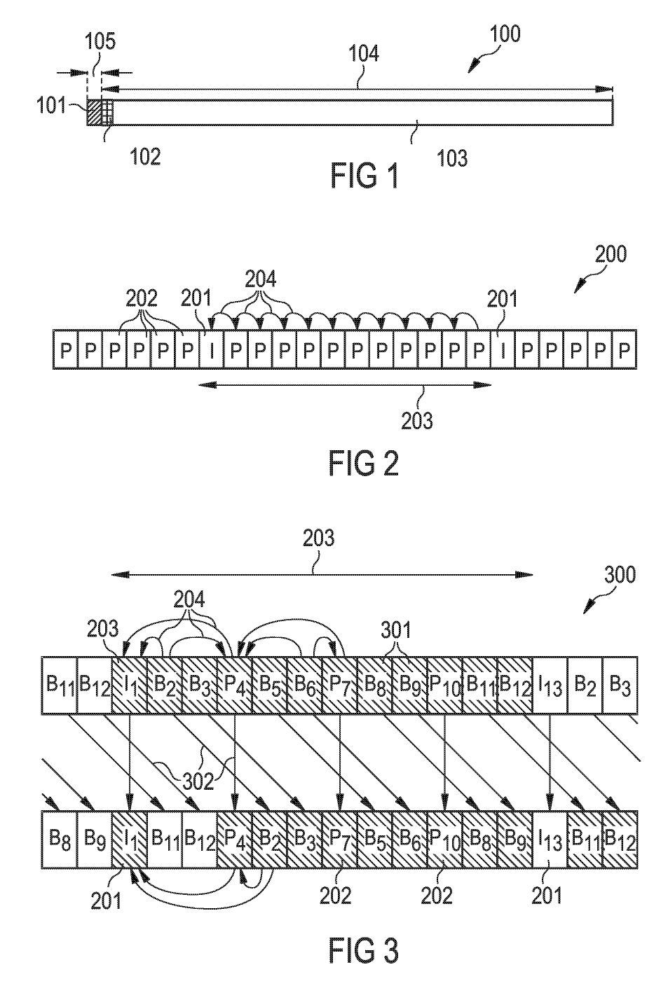

In the following, referring to FIG. 1 to FIG. 13, different aspects of trick-play implementation for transport streams according to exemplary embodiments of the invention will be described.

Particularly, several possibilities to perform trick-play on an MPEG2 encoded stream will be described, which may be partly or totally encrypted, or non-encrypted. The following description will target methods specific to the MPEG2 transport stream format. However, the invention is not restricted to this format.

Experiments were actually done with an extension, the so-called time-stamped transport stream. This comprises transport stream packets, all of which are pre-pended with a 4 bytes header in which the transport stream packet arrival time is placed. This time may be derived from the value of the program clock reference (PCR) time-base at the time the first byte of the packet is received at the recording device. This is a proper method to store the timing information with the stream, so that playback of the stream becomes a relatively easy process.

One problem during playback is to ensure that the MPEG2 decoder buffer will not overrun nor underflow. If the input stream was compliant to the decoder buffer model, restoring the relative timing ensures that the output stream is also compliant. Some of the trick-play methods described herein are independent of the time stamp and perform equally well on transport streams with and without time stamps.

FIG. 1 illustrates a time stamped transport stream packet 100 having a total length 104 of 188 Bytes and comprising a time stamp 101 having a length 105 of 4 Bytes, a packet header 102, and a packet payload 103 having a length of 184 Bytes.

This following description will give an overview of the possibilities to create an MPEG/DVB (digital video broadcasting) compliant trick-play stream from a recorded transport stream and intends to cover the full spectrum of recorded streams from those that are completely plaintext, so every bit of data can be manipulated, to streams that are completely encrypted (for instance according to the DVB scheme), so that only headers and some tables may be accessible for manipulation. The invention also addresses a solution in between these extremes, where only the data that needs to be manipulated to generate the trick-play stream is in plaintext.

When creating trick-play for an MPEG/DVB transport stream, problems may arise when the content is at least partially encrypted. It may not be possible to descend to the elementary stream level, which is the usual approach, or even access any packetized elementary stream (PES) headers before decryption. This also means that finding picture frames is not possible. Known trick-play engines need to be able to access and process this information.

In the frame of this description, the term “ECM” denotes an Entitlement Control Message. This message may particularly comprise secret provider proprietary information and may, among others, contain encrypted control words (CW) needed to decrypt the MPEG stream. Typically, control words expire in 10-20 seconds. The ECMs are embedded in packets in the transport stream.

In the frame of this description, the term “keys” particularly denotes data that may be stored in a smartcard and may be transferred to the smartcard using EMMs, that is so-called “Entitlement Management Messages” that may be embedded in the transport stream. These keys may be used by the smartcard to decrypt the control words present in the ECM. An exemplary validity period of such a key is one month.

In the frame of this description, the term “control words” (CW) particularly denotes decryption information needed to decrypt actual content. Control words may be decrypted by the smartcard and then stored in a memory of the decryption core.

In the following, some aspects related to trick-play on plaintext streams will be described.

Even if an MPEG2 stream is not encrypted (that is to say plaintext), trick-play is not trivial. An easy solution is just to output the data faster to a decoder to get a fast-forward mode, but as MPEG has timing related information encoded in its headers, this cannot just be done with the expectation to get a proper fast-forward. Besides that, it may be difficult to decide what frames to drop, as this method to perform fast-forward, may give a frame rate higher than the display rate.

Moreover, such a stream is not an MPEG2 compliant transport stream. This can be acceptable if the decoder is in the storage device but may be problematic if the signal is transferred by a standard digital interface. Furthermore, the bit rate may increase dramatically in the whole chain. If the normal play stream is a time stamped transport stream of a single program originating from satellite broadcast, the bit rate to the decoder in normal play may be around 40 Mbps and packets may be in irregular positions with gaps in between (partial transport stream). If the stream is compressed with the trick-play factor, the bit rate may be around 120 Mbps for a 3× trick-play speed. The necessary sustained bandwidth of a harddisk drive may also be increased with the trick-play factor.

So it would be appropriate to keep sending the correct amount of frames, but here a problem may occur when using a video coding technique like MPEG that exploits the temporal redundancy of video to achieve high compression ratios. Frames can no longer be decoded independently.

A structure of a plurality of groups of pictures (GOPs) is shown in FIG. 2.

Particularly, FIG. 2 shows a stream 200 comprising several MPEG2 GOP structures with a sequence of I-frames 201 and P-frames 202. The GOP size is denoted with reference numeral 203. The GOP size 203 is set to 12 frames, and only I-frames 201 and P-frames 202 are shown here.

In MPEG, a GOP structure may be used in which only the first frame is coded independently of other frames. This is the so-called intra-coded or I-frame 201. The predictive frames or P-frames 202 are coded with a unidirectional prediction, meaning that they only rely on the previous I-frame 201 or P-frame 202 as indicated by arrows 204 in FIG. 2.

Such a GOP structure has typically a size of 12 or 16 frames 201, 202. It is assumed that a trick-play speed of 2× forward is desired. So, for instance, every second frame should be skipped. This is not possible in the compressed domain due to the dependence on the reconstructed previous frame during decoding. So just dropping some compressed frames and fixing the timing information is no option.

The alternative is to decode the entire stream first, then skip every second frame and finally encode the remaining frames again. This may lead to an unacceptable complexity of the trick-play circuitry or software. So in the best case, some frames can be skipped from the GOP, on which no other frames rely. For the example of a trick-play speed of 2× with a GOP size of 12 frames, only the last 6 P-frames can be skipped. In this case, the displayed images tend to be of a “jumpy” nature, where a short normal speed period is obtained, followed by a sudden jump in time. Especially at higher trick-play speeds this may be unpleasant and does not give the viewer the look and feel of usual trick-play.

Another structure 300 of a plurality of groups of pictures (GOP) is shown in FIG. 3.

Particularly, FIG. 3 shows the MPEG2 GOP structure with a sequence of I-frames 201, P-frames 202 and B-frames 301. The GOP size is again denoted with reference numeral 203.

It is possible to use a GOP structure containing also bi-directionally predictive frames or B-frames 301 as shown in FIG. 3. A GOP size 203 of 12 frames is chosen for the example. The B-frames 301 are coded with a bi-directional prediction, meaning that they rely on a previous and a next I- or P-frame 201, 202 as indicated for some B-frames 301 by curved arrows 204. The transmission order of the compressed frames may be not the same as the order in which they are displayed.

To decode a B-frame 301, both reference frames before and after the B-frame 301 (in display order) are needed. To minimize the buffer demand in a decoder, the compressed frames may be reordered. So in transmission, the reference frames may come first. The reordered stream, as it is transmitted, is also shown in FIG. 3, lower part. The reordering is indicated by straight arrows 302. A stream containing B-frames 301 can give a nice looking trick-play picture if all the B-frames 301 are skipped. For the present example, this leads to a trick-play speed of 3× forward.

Whatever structure the stream has, the solutions described until now, may give an acceptable form of trick-play for a fast-forward mode. For reverse, the frames would have to be reordered in time, but due to the fact that MPEG uses the temporal correlation between successive frames to achieve a high compression ratio, the order in which the frames have to be decoded is fixed. Therefore, a GOP first has to be decoded in forward direction. The order of the GOPs sent to the decoder can be reversed, and GOPs can be skipped for higher reverse trick-play speeds. Reducing the GOPs by skipping P-frames or B-frames as described above is also possible in this case. Anyway, it may result in a displayed sequence of forward play and backward jumps. Therefore, the trick-play frames have to be selected from the decoded GOP and reversed in order, after which the frames are re-encoded. Then the previous GOP is fetched and processed and so on. Although possible, the complexity of such procedure may be high.

A conclusion from the foregoing considerations is that using only the I-frames in the trick-play generation may be a proper solution, because these frames can be decoded independently. As a result, the trick-play generation may be easier especially for reverse. Additionally, the use of only I-frames already allows for trick-play speeds down to 3× or 4×. For really low trick-play speeds, the more complex techniques mentioned above may be implemented.

In the following, some aspects related to a CPI (“characteristic point information”) file will be described.

Finding I-frames in a stream usually requires parsing the stream, to find the frame headers. Locating the positions where the I-frame starts can be done while the recording is being made, or off-line after the recording is completed, or semi on-line, in fact being off-line but with a small delay with respect to the moment of recording. The I-frame end can be found by detecting the start of the next P-frame or B-frame. The meta-data derived this way can be stored in a separate but coupled file that may be denoted as characteristic point information file or CPI file. This file may contain pointers to the start and eventually end of each I-frame in the transport stream file. Each individual recording may have its own CPI file.

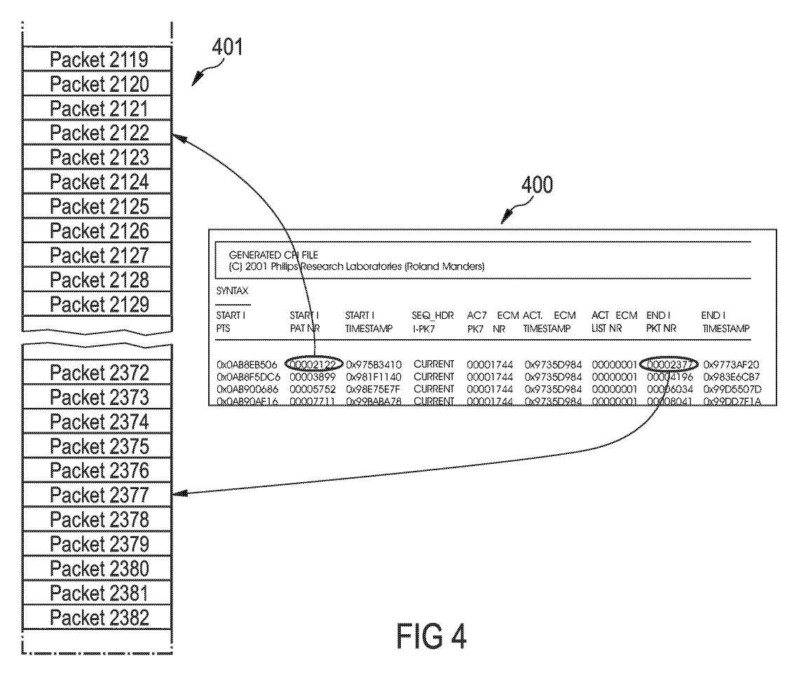

The structure of a characteristic point information file 400 is visualized in FIG. 4.

Apart from the CPI file 400, stored information 401 is shown. The CPI file 400 may also contain some other data that are not discussed here.

With the data from the CPI file 400 it is possible to jump to the start of any I-frame 201 in the stream. If the CPI file 400 also contains the end of the I-frames 201, the amount of data to read from the transport stream file is exactly known to get a complete I-frame 201. If for some reason the I-frame end is not known, the entire GOP or at least a large part of the GOP data is to be read to be sure that the entire I-frame 201 is read. The end of the GOP is given by the start of the next I-frame 201. It is known from measurements that the amount of I-frame data can be 40% or more of the total GOP data.

With the retrieved I-frames 201, a new trick-play stream that complies with the MPEG-2 transport stream format can be constructed. All that is needed is that the frames for the trick-play stream are re-multiplexed correctly, in such a manner that no buffer problems for the MPEG decoder will occur. Although this seems to be a straightforward solution, it is not a trivial solution as will become clear in the following.

Next, some aspects related to as to how to construct a trick-play stream will be described.

With the help of the CPI file, describing at what packet position an I-frame 201 starts, as well as where the I-frame 201 ends, access is provided to all I-frames 201 from the original stream. But just concatenating adequately chosen I-frames 201 into one big stream of only I-frames 201 does not result in a valid MPEG stream, as will become clear from the following.

The first point to investigate is the bit rate of the trick-play stream. For example, the original stream has an average video bit rate of 4 Mbps and a GOP size 203 of 12 frames. The bit rate may be extracted from a measurement on a real broadcast stream. It is assumed that the trick-play stream consists of I-frames 201 only that are each displayed one frame time, leading to a refresh rate of the trick-play stream equal to normal play. It is recalled that the amount of I-frame 201 data could be 40% of the GOP data. This number originates from a measurement, where the average has been around 25%. So on average 25% of the data have to be compressed into 1/12 of the time, leading to a 3 times higher bit rate. Thus the average trick-play bit rate would be 12 Mbps with peaks up to around 20 Mbps. This simple example is intended to provide some feeling for the bit rate effect and its origin.

In fact, the sizes of the I-frames 201 are known or are derivable from the measurement. Therefore, the bit rate for an I-frame 201 only trick-play stream as a function of time can easily be calculated accurately. The trick-play bit rate may be 2 to 3 times higher than the normal play bit rate and sometimes it may be higher than allowed by the MPEG2 standard. Taking into account that this is an example with a moderate bit rate stream and that streams with higher bit rates will surely be encountered, it is clear that some form of bit rate reduction has to be applied. For instance, the trick-play bit rate may be comparable to the normal play bit rate. This is especially important if the streams are sent to a decoder via a digital interface. Additional demand on bandwidth from the interface due to trick-play should be avoided. A first option is to reduce the size of the I-frames 201. However, this may add complexity and limitations in relation to trick-play for encrypted streams.

An option, which may be appropriate for particular applications, is to reduce the trick-play picture refresh rate by displaying each I-frame 201 several times. The bit rate will be reduced accordingly. This may be achieved by adding so-called empty P-frames 202 between the I-frames 201. Such an empty P-frame 202 is not really empty but may contain data instructing the decoder to repeat the previous frame. This has a limited bit cost, which can in many cases be neglected compared to an I-frame 201. From experiments it is known that trick-play GOP structures like IPP or IPPP may be acceptable for the trick-play picture quality and even advantageous at high trick-play speeds. The resulting trick-play bit rate is of the same order as the normal play bit rate. It is also mentioned that these structures may reduce the required sustained bandwidth from the storage device.

In the following, some aspects related to timing issues and stream construction will be described.

A trick-play system 500 is schematically depicted in FIG. 5.

The trick-play system 500 comprises a recording unit 501, an I-frame selection unit 502, a trick-play generation block 503 and an MPEG2 decoder 504. The trick-play generation block 503 includes a parsing unit 505, an adding unit 506, a packetizer unit 507, a table memory unit 508 and a multiplexer 509.

The recording unit 501 provides the I-frame selection unit 502 with plaintext MPEG2 data 510. The multiplexer 509 provides the MPEG2 decoder 504 with an MPEG2 DVB compliant transport stream 511.

The I-frame selector 502 reads specific I-frames 201 from the storage device 501. Which I-frames 201 are chosen depends on the trick-play speed as will be described below. The retrieved I-frames 201 are used to construct an MPEG-2/DVB compliant trick-play stream that is then sent to the MPEG-2 decoder 504 for decoding and rendering.

The position of the I-frame packets in the trick-play stream cannot be coupled to the relative timing of the original transport stream. In trick-play, the time axis may be compressed with the speed factor and additionally inversed for reverse trick-play. Therefore, the time stamps of the original time stamped transport stream may not be suitable for trick-play generation.

Moreover, the original PCR time base may be disturbing for trick-play. First of all it is not guaranteed that a PCR will be available within the selected I-frame 201. But even more important is that the frequency of the PCR time base would be changed. According to the MPEG2 specification, this frequency should be within 30 ppm from 27 MHz. The original PCR time base fulfils this requirement, but if used for trick-play it would be multiplied by the trick-play speed factor. For reverse trick-play this even leads to a time base running in the wrong direction. Therefore, the old PCR time base has to be removed and a new one added to the trick-play stream.

Finally, I-frames 201 normally contain two time stamps that tell the decoder 504 when to start decoding the frame (decoding time stamp, DTS) and when to start presenting, for instance displaying, it (presentation time stamp, PTS). Decoding and presentation may be started when DTS respectively PTS are equal to the PCR time base, which is reconstructed in the decoder 504 by means of the PCRs in the stream. The distance between, e.g., the PTS values of 2 I-frames 201 corresponds to their nominal distance in display time. In trick-play this time distance is compressed with the speed factor. Since a new PCR time base is used in trick-play, and because the distance for DTS and PTS is no longer correct, the original DTS and PTS of the I-frame 201 have to be replaced.

To solve above-mentioned complications, the I-frame 201 may first be parsed into an elementary stream in the parsing unit 505. Then the empty P-frames 202 are added on elementary stream level. The obtained trick-play, GOP is mapped into one PES packet and packetized to transport stream packets. Then corrected tables like PAT, PMT, etc. are added. At this stage, a new PCR time base together with DTS and PTS are included. The transport stream packets are pre-pended with a 4 bytes time stamp that is coupled to the PCR time base such that the trick-play stream can be handled by the same output circuitry as used for normal play.

In the following, some aspects related to trick-play speeds will be described.

In this context, firstly, fixed trick-play speeds will be discussed.

As mentioned before, a trick-play GOP structure like IPP may be used in which two (2) empty P-frames 202 follows the I-frame 201. It is assumed that the original GOP has a GOP size 203 of 12 frames and that all the original I-frames 201 are used for trick-play. This means that the I-frames 201 in the normal play stream have a distance of 12 frames and the same I-frames 201 in the trick-play stream a distance of 3 frames. This leads to a trick-play speed of 12/3=4×. If denoting the original GOP size 203 in frames by G, the trick-play GOP size in frames by T and the trick-play speed factor by N_{b}, then the trick-play speed in general is given by:

N_{b}=G/T (1)

N_{b} will also be denoted as the basic speed. Higher speeds can be realized by skipping I-frames 201 from the original stream. If every second I-frame 201 is taken, the trick-play speed is doubled, if every third I-frame 201 is taken, the trick-play speed is tripled and so on. In other words, the distance between the used I-frames 201 of the original stream is 2, 3 and so on. This distance may be always an integer number. If denoting the distance between the I-frames 201 used for trick-play generation by D (D=1 meaning that every I-frame 201 is used), then the general trick-play speed factor N is given by:

N=D*G/T (2)

This means that all integer multiples of the basic speed can be realized, leading to an acceptable set of speeds. It should be noticed that D is negative for reverse trick-play and that D=0 results in a still picture. Data can only be read in a forward direction. Therefore, in reverse trick-play, data is read forward and jumps are made backwards to retrieve the preceding I-frame 201 given by D. It should also be noticed that a larger trick-play GOP size T results in a lower basic speed. For instance, IPPP leads to a finer grained set of speeds than IPP.

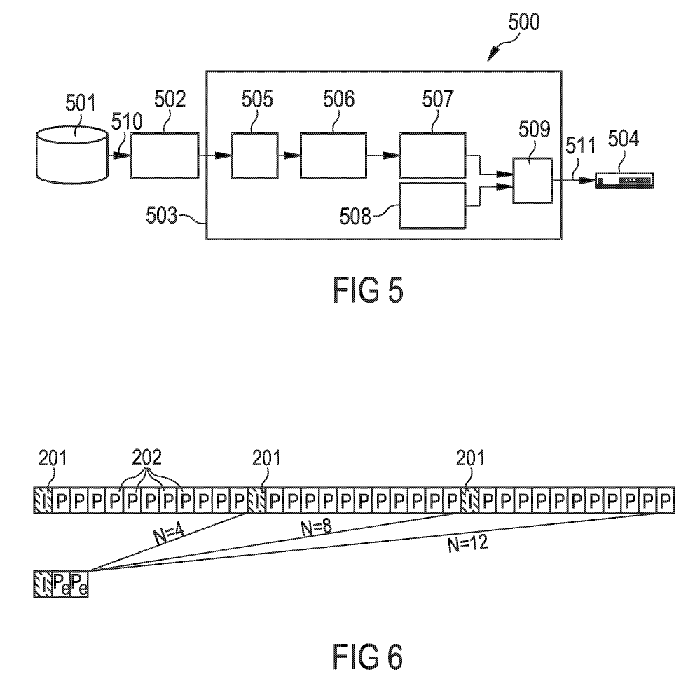

In the following, referring to FIG. 6, time compression in trick-play will be explained.

FIG. 6 shows the situation for T=3 (IPP) and G=12. For D=2, an original display time of 24 frames is compressed into a trick-play display time of 3 frames resulting in N=8. In the given example, the basic speed is an integer but this is not necessarily the case. For G=16 and T=3, the basic speed is 16/3=5 ⅓. which does not result in a set of integer trick-play speeds. Therefore, the IPPP structure (T=4) is better suited for a GOP size of 16 resulting in a basic speed of 4×. If a single trick-play structure is desired that fits to the most common GOP sizes of 12 and 16, IPPP may be chosen.

Secondly, arbitrary trick-play speeds will be discussed.

In some cases, the set of trick-play speeds resulting from the method described above is satisfying, in some cases not. In the case of G=16 and T=3 one probably still would prefer integer trick-play speed factors. Even in the case of G=12 and T=4 it might be preferred to have a speed not available in the set like for instance 7×. Now, the trick-play speed formula will be inverted and the distance D will be calculated which is given by:

D=N*T/G (3)

Using the above example with G=12, T=4 and N=7 results in D=2 ⅓. Instead of skipping a fixed number of I-frames 201, an adaptive skipping algorithm might be used that chooses the next I-frame 201 based on the fact what I-frame 201 best matches the required speed. To choose the best matching I-frame 201, the next ideal point Iₚ with the distance D may be calculated and one of the I-frames 201 may be chosen closest to this ideal point to construct a trick-play GOP. In the following step, again the next ideal point may be calculated by increasing the last ideal point by D.

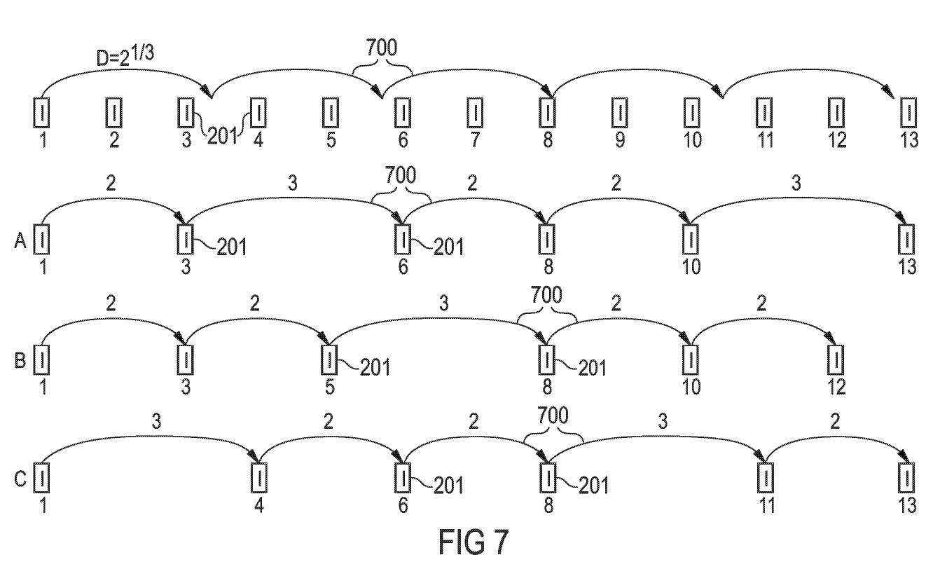

As visualized in FIG. 7 illustrating trick-play with fractional distances, there are particularly three possibilities to choose the I-frame 201:

A. The I-frame closest to the ideal point; I=round(Ip)

B. The last I-frame before the ideal point; I=int(Ip)

C. The first I-frame after the ideal point; I=int(Ip)+1

As can clearly be seen, the actual distance is varying between int(D) and int(D)+1, the ratio between the occurrences of the two being dependent on the fraction of D, such that the average distance is equal to D. This means that the average trick-play speed is equal to N, but that the actually used frame has a small jitter with respect to the ideal frame. Several experiments have been performed with this, and although the trick-play speed may vary locally, this is not visually disturbing. Usually, it is not even noticeable especially at somewhat higher trick-play speeds. It is also clear from FIG. 7 that it makes no essential difference whether to choose method A, B or C.

With this method, trick-play speed N does not need to be an integer but can be any number above the basic speed N_{b}. Also speeds below this minimum can be chosen, but then the picture refresh rate may be lowered locally because the effective trick-play GOP size T is doubled or at still lower speeds even tripled or more. This is due to a repetition of the trick-play GOPs, as the algorithm will choose the same I-frame 201 more than once.

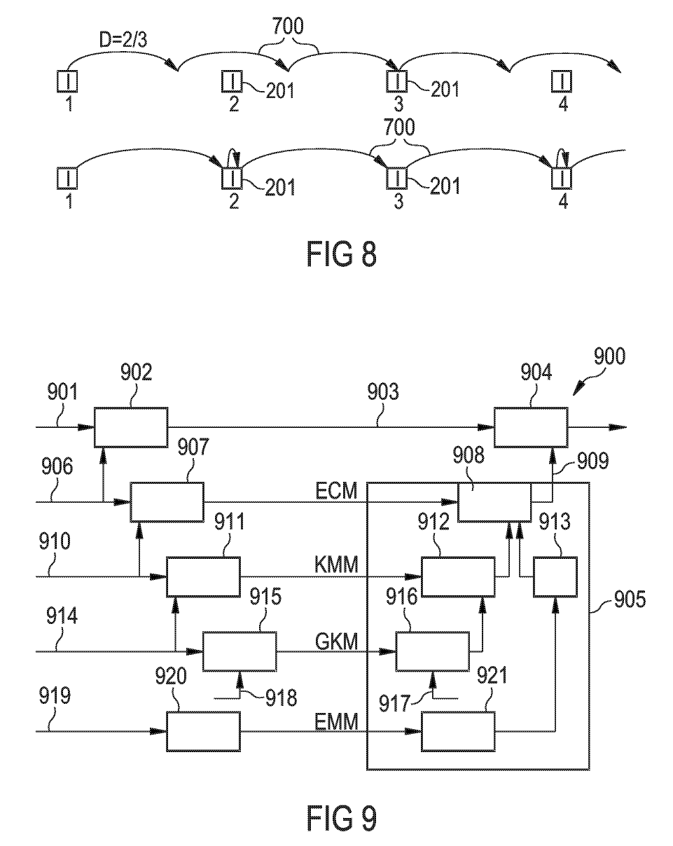

FIG. 8 shows an example for D=⅔ which is equivalent to N=⅔ N_{b}. Here, the round function is used to select the I-frames 201 and as can be seen frames 2 and 4 are selected twice.

Anyway, the described method will allow for a continuously variable trick-play speed. For reverse trick-play a negative value is chosen for N. For the example of FIG. 7 this simply means that the arrows 700 are pointing in the other direction. The method described will also include the sets of fixed trick-play speeds mentioned earlier and they will have the same quality, especially if the round function is used. Therefore, it might be appropriate that the flexible method described in this section should always be implemented whatever the choice of the speeds will be.

In the following, some aspects related to the refresh rate of the trick-play picture will be discussed.

The term “refresh rate” particularly denotes the frequency with which new pictures are displayed. Although not speed dependent, it will be briefly discussed here because it can influence the choice of T. If the refresh rate of the original picture is denoted by R (25 Hz or 30 Hz), the refresh rate of the trick-play picture (Rₜ) is given by:

Rₜ=R/T (4)

With a trick-play GOP structure of IPP (T=3) or IPPP (T=4), the refresh rate Rₜ is 8 ⅓ Hz respectively 6 ¼ Hz for Europe and 10 Hz respectively 7 ½ Hz for the USA. Although the judgement of trick-play picture quality is a somewhat subjective matter, there are clear hints from experiments that these refresh rates are acceptable for low speeds and even advantageous at higher speeds.

In the following, some aspects related to encrypted stream environments will be described.

In the following, some information about encrypted transport streams is presented as a basis for the description of trick-play on encrypted streams. It is focused on the Conditional Access System used for broadcast.

FIG. 9 illustrates a conditional access system 900 which will be described in the following.

In the conditional access system 900, content 901 may be provided to a content encryption unit 902. After having encrypted the content 901, the content encryption unit 902 supplies a content decryption unit 904 with encrypted content 903.

A control word 906 may be supplied to the content encryption unit 902 and to a ECM generation unit 907. The ECM generation unit 907 generates an ECM and provides the same to an ECM decoding unit 908 of a smartcard 905. The ECM decoding unit 908 generates from the ECM a control word, that is to say decryption information that is needed and provided to the content encryption unit 904 to decrypt the encrypted content 903.

Furthermore, an authorization key 910 is provided to the ECM generation unit 907 and to a KMM generation unit 911, wherein the latter generates a KMM and provides the same to a KMM decoding unit 912 of the smartcard 905. The KMM decoding unit 912 provides an output signal to the ECM decoding unit 908.

Moreover, a group key 914 may be provided to the KMM generation unit 911 and to a GKM generation unit 915 which may further be provided with a user key 918. The GKM generation unit 915 generates a GKM signal GKM and provides the same to a GKM decoding unit 916 of the smartcard 905, wherein the GKM decoding unit 916 gets as a further input a user key 917.

Beyond this, entitlements 919 may be provided to an EMM generation unit 920 that generates an EMM signal and provides the same to an EMM decoding unit 921. The EMM decoding unit 921 located in the smartcard 905 is coupled with an entitlement list unit 913 which provides the ECM decoding unit 908 with corresponding control information.

ECM denotes Entitlement Control Messages, KMM denotes Key Management Messages, GKM denotes Group Key Messages, and EMM denotes Entitlement Management Messages.

In many cases, content providers and service providers want to control access to certain content items through a conditional access (CA) system.

To achieve this, the broadcasted content 901 is encrypted under the control of the CA system 900. In the receiver, content is decrypted before decoding and rendering if access is granted by the CA system 900.

The CA system 900 uses a layered hierarchy (see FIG. 9). The CA system 900 transfers the content decryption key (control word CW 906, 909) from server to client in the form of an encrypted message, called ECM (Entitlement Control Message). ECMs are encrypted using an authorization key (AK) 910. For security reasons, the CA server 900 may renew the authorization key 910 by issuing a KMM (Key Management Message). A KMM is in fact a special type of EMM (Entitlement Management Message), but for clarity the term KMM may be used. KMMs are also encrypted using a key that for instance can be a group key (GK) 914, which is renewed by sending a GKM (Group Key Message) that is again a special type of EMM. GKMs are then encrypted with the user key (UK) 917, 918, which is a fixed unique key embedded in the smartcard 905 and known by the CA system 900 of the provider only. Authorization keys and group keys are stored in the smartcard 905 of the receiver.

Entitlements 919 (for instance viewing rights) are sent to individual customers in the form of an EMM (Entitlement Management Message) and stored locally in a secure device (smartcard 905). Entitlements 919 are coupled to a specific program. An entitlements list 913 gives access to a group of programs depending on the type of subscription. ECMs are only processed into keys (control words) by the smartcard 905 if an entitlement 919 is available for the specific program. Entitlement EMMs are subject to an identical layered structure as the KMMs (not depicted in FIG. 9).

In an MPEG2 system, encrypted content, ECMs and EMMs (including the KMM and GKM types) are all multiplexed into a single MPEG2 transport stream.

The description above is a generalized view of the CA system 900. In digital video broadcasting, only the encryption algorithm, the odd/even control word structure, the global structure of ECMs and EMMs and their referencing are defined. The detailed structure of the CA system 900 and the way the payloads of ECMs and EMMs are encoded and used are provider specific. Also the smartcard is provider specific. However, from experience it is known that many providers follow essentially the structure of the generalized view of FIG. 9.

In the following, DVB Encryption/Decryption topics will be discussed.

The applied encryption and decryption algorithm is defined by the DVB standardisation organisation. In principle two encryption possibilities are defined namely PES level encryption and TS level encryption. However, in real life mainly the TS level encryption method is used. Encryption and decryption of the transport stream packets is done packet based. This means that the encryption and decryption algorithm is restarted every time a new transport stream packet is received. Therefore, packets can be encrypted or decrypted individually. In the transport stream, encrypted and plaintext packets are mixed because some stream parts are encrypted (e.g. audio/video) and others are not (e.g. tables). Even within one stream part (e.g. video) encrypted and plaintext packets may be mixed.

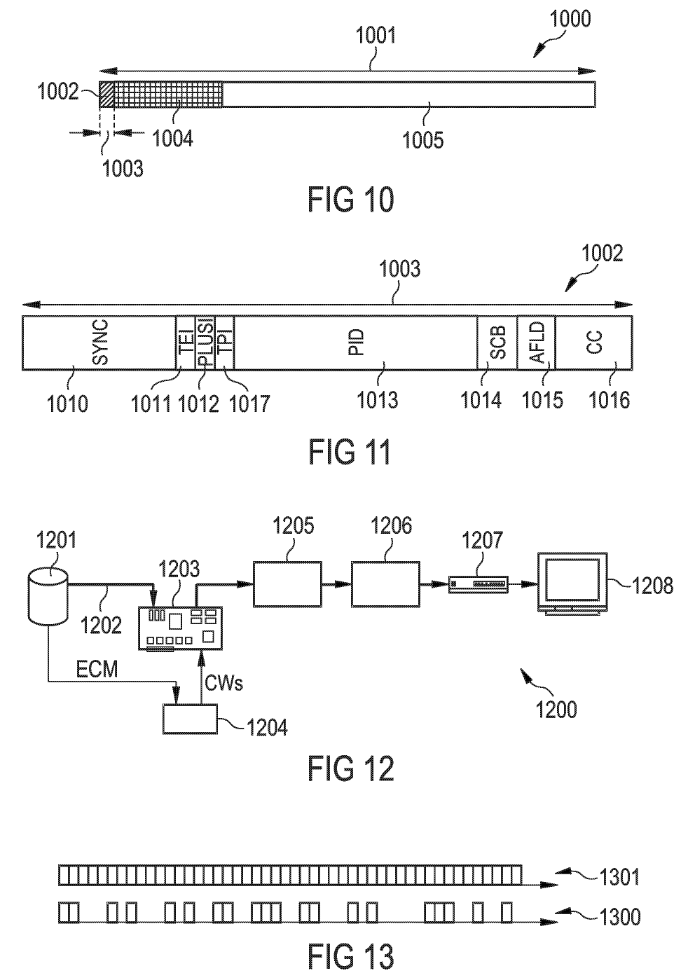

In the following, referring to FIG. 10, a DVB encrypted transport stream packet 1000 will be described.

The stream packet 1000 has a length 1001 of 188 Bytes and comprises three portions. A packet header 1002 has a size 1003 of 4 Bytes. Subsequent to the packet header 1002, an adaptation field 1004 may be included in the stream packet 1000. After that, a DVB encrypted packet payload 1005 may be sent.

FIG. 11 illustrates a detailed structure of the transport stream packet header 1002 of FIG. 10.

The transport stream packet header 1002 comprises a synchronization unit (SYNC) 1010, a transport error indicator (TEI) 1011 which may indicate transport errors in a packet, a payload unit start indicator (PLUSI) 1012 which may particularly indicate a possible start of a PES packet in the subsequent payload 1005, a transport priority unit (TPI) 1017 indicating priority of the transport, a packet identifier (PID) 1013 used for determining the assignment of the package, a transport scrambling control (SCB) 1014 to select the CW that is needed for decrypting the transport stream packet, an adaptation field control (AFLD) 1015, and a continuity counter (CC) 1016.

Thus, FIG. 10 and FIG. 11 show the MPEG2 transport stream packet 1000 that has been encrypted and which comprises different parts:

Packet header 1002 is in plaintext. It serves to obtain important information such as a packet identifier (PID) number, presence of an adaptation field, scrambling control bits, etc.

Adaptation field 1004 is also in plaintext. It can contain important timing information such as the PCR.

DVB Encrypted Packet Payload 1005 contains the actual program content that may have been encrypted using the DVB algorithm.

In order to select the correct CW that is needed to decrypt the broadcasted program it is necessary to parse the transport stream packet header. A schematic overview of this header is given in FIG. 11. An important field for the decryption of the broadcasted program is the scrambling control bits (SCB) field 1014. This SCB field 1014 indicates which CW the decrypter must use to decrypt the broadcasted program. Moreover, it indicates whether the payload of the packet is encrypted or in plaintext. For every new transport stream packet, this SCB 1014 must be parsed since it changes over time and can change from packet to packet.

In the following, some aspects related to trick-play on fully encrypted streams will be described.

The first reason why this is an interesting topic is that trick-play on plaintext and fully encrypted streams are the two extremes of a range of possibilities. Another reason is that there exist applications in which it may be necessary to record fully encrypted streams. Thus, it would be useful to have a technique at hand to perform trick-play on a fully encrypted stream. A basic principle is to read a large enough block of data from the storage device, decrypt it, select an I-frame in the block and construct a trick-play stream with it.

Such a system 1200 is depicted in FIG. 12

FIG. 12 shows the basic principle of trick-play on a fully encrypted stream. For this purpose, data stored in a harddisk 1201 are provided as a transport stream 1202 to a decrypter 1203. Further, the harddisk 1201 provides a smartcard 1204 with an ECM, wherein the smartcard 1204 generates control words from this ECM and sends the same to the decrypter 1203.

Using the control words, the decrypter 1203 decrypts the encrypted transport stream 1202 and sends the decrypted data to an I-frame detector and filter 1205. From there, the data are provided to an insert empty P frame unit 1206 which conveys the data to a set top box 1207. From there, data are provided to a television 1208.

In the following, some aspects will be mentioned with respect to the question what a recording contains.

Making a recording of a single channel, the recording must contain all the data required to playback the recording of the channel at a later stage. One can resort to just record everything on a certain transponder, but this way one would record far more than one needs to playback the program intended to record. This means that both bandwidth and storage space would be wasted. So instead of this, only the packets really needed should be recorded. For each program this means one must record all the MPEG2 mandatory packets like PAT (program association table), CAT (conditional access table), and obviously for each program the video and audio packets as well as the PMT (program map table) that describes which packets belong to a program. Furthermore, the CAT/PMT may describe CA packets (ECMs) needed for decryption of the stream. Unless the recording is made in plaintext after decryption, those ECM packets have to be recorded as well.

If the recording made does not consist of all packets from the full multiplex, the recording becomes a so-called partial transport stream 1300 (see FIG. 13). Further, FIG. 13 illustrates a full transport stream 1301. The DVB standard requires that if a partial transport stream 1300 is played, all normal DVB mandatory tables like NIT (network information table), BAT (bouquet association table) etc. are removed. Instead of these tables, the partial stream should have SIT (selection information table) and DIT (discontinuity information table) tables inserted.

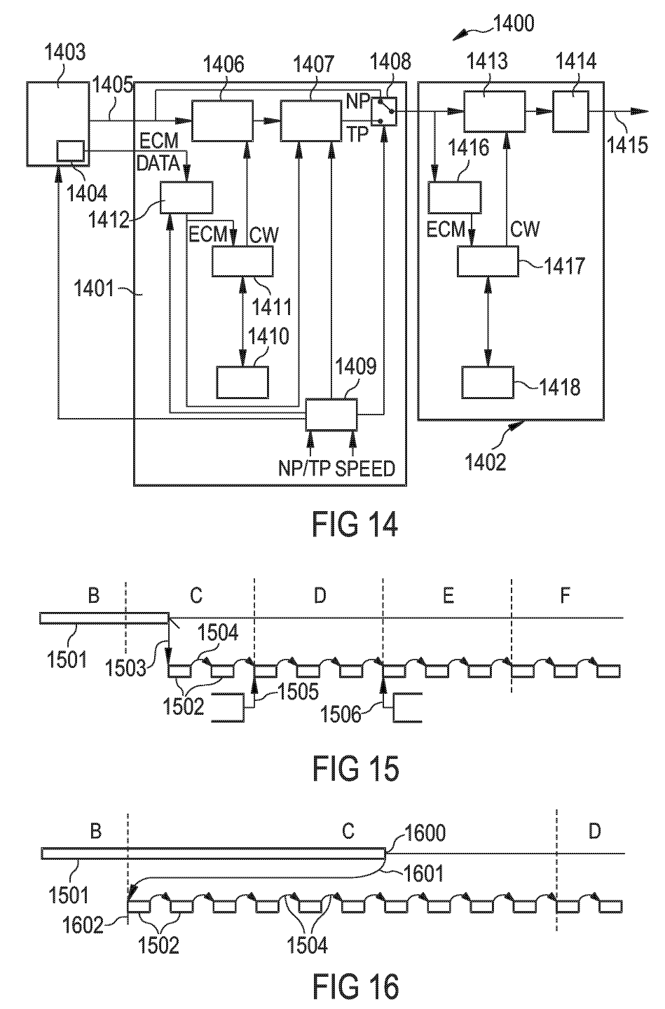

In the following, referring to FIG. 14 to FIG. 32, systems will be described which are capable of processing an encrypted data stream in a cryptographic system according to exemplary embodiments of the invention.

It is emphasized that the systems described in the following can be implemented in the frame of and in combination with any of the systems described referring to FIG. 1 to FIG. 13.

In the following, some aspects related to switching from normal play to trick-play will be described.

The switching from normal play to trick-play may result in some special effects. The influence of buffers in other parts of the playback chain will not be the primary aspect of the following considerations. It is also assumed that PID (packet identifier) numbers in a trick-play stream are identical to a normal play stream to avoid the effects of deviating PID numbers.

The following section particularly concentrates on the switching effects of the decryption process, an interruption of which would increase the transition time to trick-play. Actual behaviour may depend on the availability of control words (CWs) and therefore on the handling and processing of ECMs (entitlement control messages).

Referring to FIG. 14, a trick-play system 1400 will be described.

The trick-play system 1400 includes a storage device 1403, a trick-play generator 1401 and a receiver 1402.

The storage device 1403 stores data to be reproduced which are provided as a transport stream 1405 to a decrypter unit 1406 and to a switch unit 1408 of the trick-play generator 1401. The switch unit 1408 may switch between a normal play mode (NP) and a trick-play mode (TP). Via a control unit 1409, the speed of a desired trick-play may be selectively input as well as the fact whether a normal play or a trick-play is desired. This information is provided from the control unit 1409 to the storage device 1403. The control unit 1403 is, for instance, controlled by a user via a user interface. Further, the control unit 1409 provides the entered data or commands to a trick-play stream construction unit 1407 and to an ECM memory unit 1412.

The storage device 1403 transmits the transport stream not only to the decrypter unit 1406 and to the switch unit 1408, but also provides ECM data stored in an ECM file 1404 to an ECM memory unit 1412. The ECM memory unit 1412 that also receives the parameters from the control unit 1409 provides the trick-play stream construction unit 1407 and a smartcard interface unit 1411 with ECM data. Further, the smartcard interface unit 1411 is adapted to communicate with a smartcard 1410.

The smartcard 1410 generates control words (CW) and provides the control words via the smartcard interface unit 1411 to the decrypter unit 1406.

In a normal play mode, the position of the switch of the switch unit 1408 is as shown in FIG. 14. In this operation mode, the transport stream 1405 is directly provided to the receiver unit 1412. However, when a trick-play mode is selected, the switch will go to the other position as shown in FIG. 14, so that the transport stream 1405 will be processed by the trick-play stream construction unit 1407 which will provide trick-play data to the receiver 1402, more particularly to a decrypter unit 1413 of the receiver 1402 and to an ECM extractor unit 1416 of the receiver 1402.

An ECM extractor unit 1416 will supply ECMs to a smartcard interface 1417 that is communicatively coupled to smartcard 1418. In response to the ECMs, the smartcard interface 1417 provides the decrypter unit 1413 with control words as decryption information. After having passed the decrypter unit 1413, the data are passed to a decoder/renderer unit 1414 from where the data may be transmitted to a display unit 1415.

As depicted in FIG. 14, there are particularly two aspects that have to be considered. The first one is the effect on the receiver 1402 that may decrypt, decode and render a signal that is switched between normal play and trick-play. The second one is the effect of the switching in relation to the trick-play generator 1401.

In the following, the receiver unit 1402 will be further described.

The trick-play stream generated according to the techniques described herein may be a plaintext stream. In this case, no decryption of the trick-play stream is necessary in the receiver 1402 and the MPEG decoding can start immediately after the switching to trick-play.

In the following, the trick-play generator 1401 will be further described.

The trick-play generator 1401 may decrypt the stream in order to select the plaintext I-frames and construct a trick-play stream from it. This decrypt process should start as soon as possible after switching to trick-play. Among others the number of CWs per ECM influences this decryption process. This information is regarded as being known (e.g. from the CPI file, see FIG. 4 and corresponding description), because it is also necessary for the continuous trick-play generation. The switching effects are described hereafter.

First, so-called “blind switching” will be described. This means basically that the decrypter status is unknown and might thus be wrong. However, this scheme may allow trick-play switching with low computational burden.

Then, “fast switching” will be described. In this case the decrypter status is assumed to be given by history and can be used to improve the switching speed.

Finally, optimisation of the switching position will be described.

In the following, “blind switching” will be described.

Firstly, a situation will be considered in which there is no knowledge about the status of the decrypter registers, or that they might contain totally wrong CWs. So, a certain initialisation may be performed at a start. For this, it is necessary to know where trick-play processing starts. It may be assumed that the trick-play stream starts at the location of the normal play stream at the switching moment. This implies that the CW to decrypt the current period is needed first. So the scheme may start by sending the ECM of the current period to the smartcard. It should be ensured that this ECM is processed. This is not guaranteed by a change in table ID because the history is assumed to be unknown. Instead, the ECM extractor of the trick-play generator can be reset during normal play by bringing it in the same state as after the insertion of a smartcard. The effect is that the first ECM encountered after this reset will always be sent to the smartcard irrespective of its table ID. After the latency of the smartcard, the trick-play processing can be started. The exact method depends on whether forward play or reverse play shall be performed and on whether one or two CWs per ECM are provided. The same parameters may also ask for additional initialisation steps at the instant the trick-play processing is started.

Particularly, two different scenarios or stream types may be distinguished:

According to a stream type I, two control words (CWs) are provided per Entitlement Control Message (ECM).

According to a stream type II, one control word (CW) is provided per Entitlement Control Message (ECM). For stream type II, switching from normal-play to trick-play may occur latest at a certain distance, for instance 600 ms, before the end of a particular period.

The effects and its consequences are described hereafter for each situation.

A first scenario may be denoted as “forward and two CWs”.

In the case of forward trick-play, the next CW needed for trick-play generation is the CW of the next period. The ECM sent to the smartcard at start-up also contained this CW. No additional steps are necessary. The first ECM sent automatically by the trick-play generator is the one of the next period.

FIG. 15 shows a sequence of periods of a data stream. A first period is denoted as B, a second period is denoted as C, a third period is denoted as D, a fourth period is denoted as E and a fifth period is denoted as F. FIG. 15 further illustrates a switch from a normal play mode 1501 to a trick-play mode 1502, wherein the switching point of time is denoted with reference numeral 1503. At time 1503, an ECM C table ID 0×80 is sent. In the normal play mode 1501, the entire data stream is replayed continuously. In the trick-play mode 1502, not the entire data stream is replayed, but only some portions, wherein arrows 1504 indicate jumps between displayed portions over non-displayed portions of the data stream.

Referring to stream type I; at a point of time 1505, an ECM D is sent with table ID 0×81. At the point of time 1506, an ECM E is sent with table ID 0×80

Another scenario may be denoted as “forward and one CW”

This situation is also depicted in FIG. 15 for stream type II.

For the case of stream type II, an ECM E with table ID 0×80 is sent at the point of time 1505. At the point of time 1506, an ECM F is sent with table ID 0×81.

Switching occurs during period C. In this case, the CW for the next period D is not present in ECM C. The first ECM that is sent automatically by the trick-play generator is the one of period E. The word “automatically” may particularly refer to the way ECMs are sent in continuous trick-play. As this ECM E has a table ID identical to the ECM C sent at start-up it will not be processed. So two complete periods are lost, namely D and E. This may be corrected in the following way, as can also be taken from FIG. 16. The trick-play engine assumes that the current period C was just entered and starts trick-play generation at the beginning of this period instead of at the last normal play position. It then also sends the ECM of the next period D to the smartcard. As this ECM has a different table (ID 0×81) from ECM C sent at start-up (ID 0×80), it will be correctly processed. A complete period C is now available for the decryption of ECM D. This ensures that the decrypted CW D is available in time even at the highest trick-play speed. This also means that the first trick-play pictures may be a repetition of the last normal play pictures. Experiments have shown this effect which is in many cases acceptable.

Another scenario may be denoted as “generalized switching to forward trick-play” and will be explained in the following, also referring to FIG. 16.

In the shown scenario, a point of time 1600 is indicated at which an ECM C is sent. A switch to trick-play occurs after the system has waited for smart card latency 1601.

The alternative method can also be used in the case of two CWs per ECM. In this case, the first ECM sent by the trick-play generator is identical to the one sent at start-up. The repeated ECM is then not processed, which is no problem. So a generalized approach for switching from normal play to forward trick-play as depicted in FIG. 16 may be as follows:

During normal play 1501, the ECM extractor in the trick-play generator is reset;

At the switching moment, the ECM of the current period is sent first; that is the period in which the last normal play position is located;

After the latency 1601 of the smartcard, the trick-play processing is started, the first trick-play block being read from the start of the current period;

The trick-play generator assumes that the current period was just entered and sends an ECM accordingly at a point of time 1602 (depending on one or two CWs). For stream type I, an ECM C is sent here. For stream type II, an ECM D is sent here.

Another scenario may be denoted as “reverse and two CWs”.

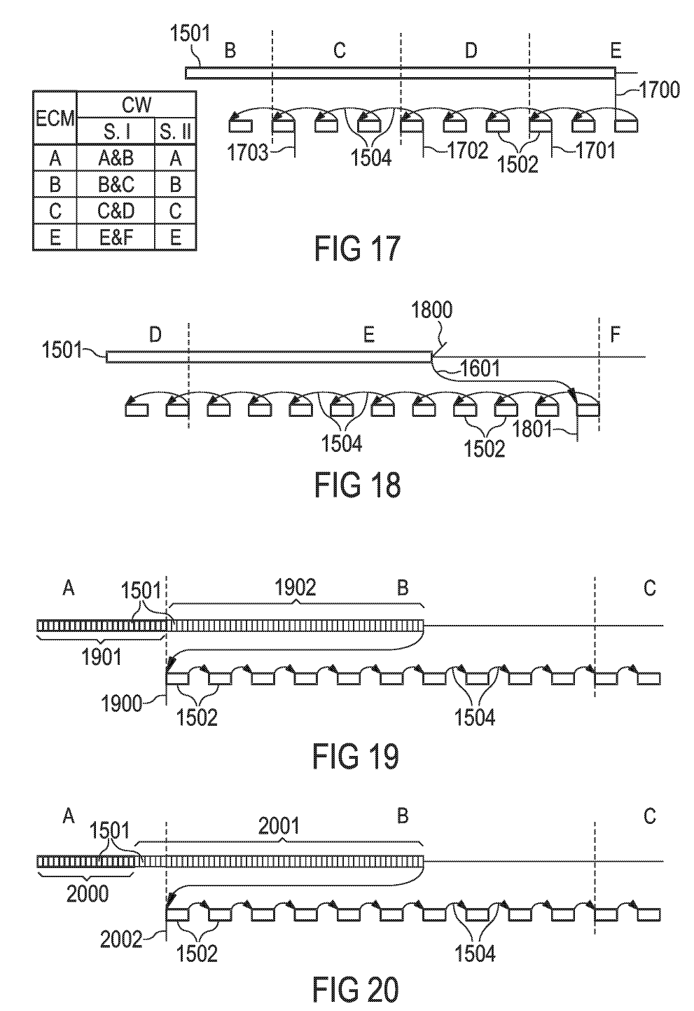

Again, the assumption is made that trick-play starts at the last normal play position. In FIG. 17 it is indicated that switching occurs at a point of time 1700 during period E at which moment ECM E (Table ID 0×80) is sent to the smartcard. In reverse trick-play, the CW needed after the one for the current period E is the one of the previous period D. The ECM E sent at start-up does not contain this CW D. The first ECM sent automatically by the trick-play generator is ECM C at a point of time 1701. This ECM does hold CW D but because this ECM C has the same table (ID 0×80) as the ECM E sent at start-up it will not be processed. The first ECM processed correctly will be ECM B sent at a point of time 1702 that contains CWs B and C. ECM A is sent at a point of time 1703.

CW D will not be available in the decrypter. As a consequence, between one and two periods will be lost, namely period D completely and period C partly. How much of period C is lost depends on the trick-play speed and the smartcard latency. This will interrupt the trick-play stream.

This problem can be solved by sending at start-up the ECM D of the previous period instead of the ECM E of the current period. This will load the necessary CWs D and E of the previous and current period into the decrypter registers. Also the first ECM sent automatically by the trick-play generator being ECM C may now be correctly processed.

Another scenario may be denoted as “reverse and one CW”.

The same initial or start situation as for “reverse and two CWs” is considered (see FIG. 17 again). So ECM E is sent at start-up 1700 and the first ECM processed correctly is ECM B. But in this case, the ECMs hold only one CW. So ECM B only contains CW B and not CW C. As a consequence, two periods are lost.

However, the following correction may be performed. As already mentioned, ECM E of the current period is sent at start-up 1700. But then, after the latency of the smartcard, the trick-play processing will start at the end of the current period E instead of at the last normal play position. This means jumping to a position corresponding to the end of the current period E minus the block size. The trick-play engine then further assumes that the current period E has just been entered and sends (automatically) the ECM D of the previous period in the normal play stream. This ECM D will be correctly processed because ECM E and D have different table IDs and the smartcard already has finished the processing of ECM E. Jumping to the end of the period ensures a timely decryption of this ECM D even at the highest trick-play speed. Then, the normal trick-play processing may be continued. Of course, the next ECM C may now also be correctly processed.

Another scenario may be denoted as “generalized switching to reverse trick-play”.

The method described for “reverse and one CW” can also be used for “reverse and two CWs”. The sending at start-up of the ECM of the current period guarantees the correct decryption of the data in this period for both cases. After the sending and processing of the second ECM, being the ECM of the previous normal play period, the content of the decrypter registers have become identical for both situations.

So, a generalized switching from normal play to reverse trick-play, as depicted in FIG. 18, is as follows:

During normal play 1501, the ECM extractor in the trick-play generator is reset;

At the switching moment, the ECM of the current period is first sent; that is the period in which the last normal play position is located;

After the latency 1601 of the smartcard, the trick-play processing 1502 is started, the first trick-play block being read from the end of the current period;

The trick-play generator assumes that the current period was just entered and sends an ECM accordingly (the ECM of the previous period D at a point of time 1801).

In the following, “fast switching” will be described.

In the previously described case of blind switching, it was assumed that there is no knowledge about the status of the decrypter registers. As a consequence, an initialising ECM has to be sent first, and the trick-play processing can only start after this ECM has been decrypted by the smartcard. This introduces an additional delay equal to the latency of the smartcard. However, this additional delay can be avoided if the registers of the decrypter already hold useful CWs. Whether this is the case or not depends on the system configuration.

It will be assumed for a moment that the trick-play generator 1401 and receiver 1402 are in one and the same box and that they share the use of the decrypter. There is no sharing violation in this case because the receiver 1402 only uses the decrypter in normal play 1501 and the trick-play generator 1401 only in trick-play 1502.

The status of the decrypter at the switching moment in this system configuration is of interest. It is clear that the CW needed to decrypt the current period should already be in the register of the common decrypter because it was being used to decrypt this period in normal play. This fact omits the need to send an initialising ECM, thus avoiding the additional delay. Trick-play processing can start immediately. The decrypter will also hold the ECM of the previous or next period depending on the one/two CW per ECM situation. This does not really matter for the decryption of the current period, which is the first step of trick-play processing, but it can influence the continuation of the trick-play generation process. The trick-play processing could be interrupted if the first ECM sent by the trick-play generator is not processed because it has the same table ID as the last normal play ECM. This can be evaluated for each individual case. It should also be considered that stream type II starts sending ECMs for a new period around a predetermined time period before it is entered. This predetermined time period may be defined by the time distance between the actual table ID toggle of the ECM and the SCB toggle of the encrypted data transport stream packets. This distance should be larger than the maximum latency of the smartcard. For example, current smartcards have a latency of approximately 600 ms.

A scenario discussed in the following may be denoted as “forward and stream type I”.

When switching during period B, trick-play processing is started at the start of period B. The last normal play ECM is ECM B. The first ECM sent by the trick-play generator is also ECM B. So it will not be processed a second time, which is of course no problem.

The latter scenario is illustrated in FIG. 19.

A portion 1901 of normal play 1501 in period A relates to Table ID 0×80. The portion 1902 of normal play 1501 in period B relates to Table ID 0×81. At a point of time 1900, ECM B (CW B & CW C) is sent.

A scenario discussed in the following may be denoted as “forward and stream type II but not in a predetermined time interval before the end of the current period”, for instance the last 600 ms.

In this case, a switch is performed during period B, but not in the predetermined time interval before the end of the current period. The last normal play ECM is ECM B. The first ECM sent by the trick-play generator is ECM C, which has a different table ID. So it will be processed correctly.

The latter scenario is illustrated in FIG. 20.

A portion 2000 of normal play 1501 relates to Table ID 0×80. A portion 2001 of normal play 1501 relates to Table ID 0×81. At a point of time 2002, ECM C (CW C) is sent.

A scenario discussed in the following may be denoted as “forward and stream type II within the predetermined time interval before the end of the current period”.

Here, the switching occurs when the predetermined time interval before the end of period B has arrived. The last normal play ECM is now ECM C. The first ECM sent by the trick-play generator is also ECM C. So it will not be processed a second time, which is of course no problem.

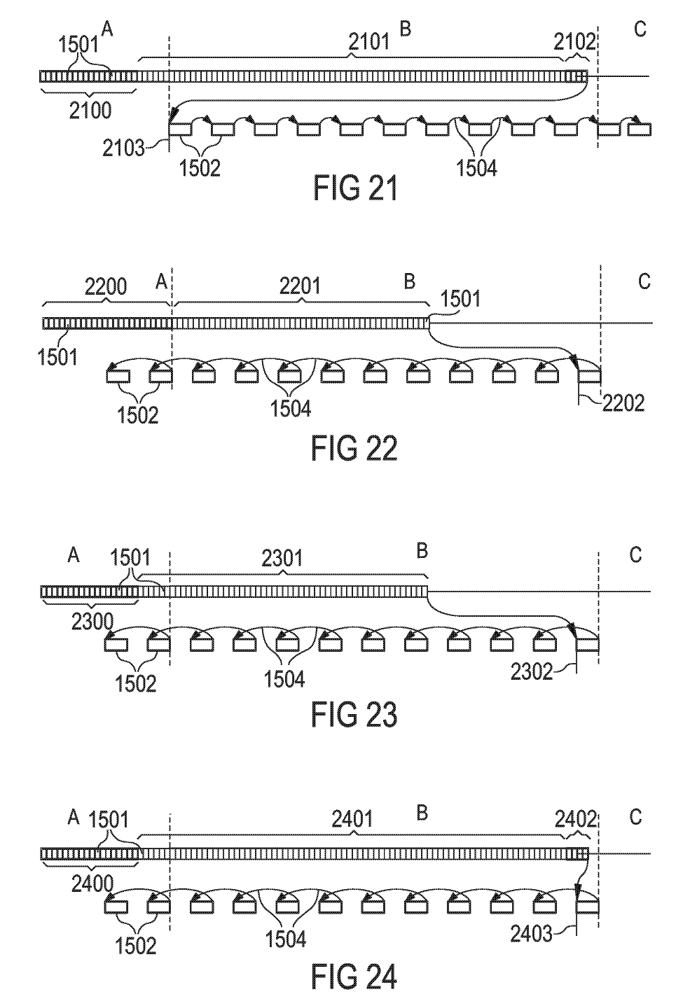

The latter scenario is illustrated in FIG. 21.

The portions 2100 and 2102 of normal play 1501 relate to Table ID 0×80. The portion 2101 of normal play 1501 relates to Table ID 0×81. At point of time 2103, ECM C (CW C) is sent.

A scenario discussed in the following may be denoted as “reverse and stream type I”.

When switching during period B, trick-play processing is started with a block at the end of period B. The last normal play ECM is ECM B. The first ECM sent by the trick-play generator is ECM A, which has a different table ID. So it will be processed correctly.

The latter scenario is illustrated in FIG. 22.

The portion 2200 of normal play 1501 in period A relates to Table ID 0×80. The portion 2201 of normal play 1501 in period B relates to Table ID 0×81. At point of time 2202, ECM A (CW A+CW B) is sent.

Another scenario discussed in the following may be denoted as “reverse and stream type II but not in the predetermined time interval before the end of the current period”.

In this case, switching occurs during period B but not in the predetermined time interval before the end of the current period. The last normal play ECM is ECM B. The first ECM sent by the trick-play generator is ECM A, which has a different table ID. So it will be processed correctly.

The latter scenario is illustrated in FIG. 23.

A portion 2300 of normal play 1501 in period A relates to Table ID 0×80. A portion 2301 of normal play 1501 in period B relates to Table ID 0×81. At a point of time 2302, ECM A (CW A) is sent.

Another scenario discussed in the following may be denoted as “reverse and stream type II within the predetermined time interval before the end of the current period”.

Here, the switching occurs upon arrival in the predetermined time interval before the end of period B. This scenario is illustrated in FIG. 24.

Portions 2400 and 2402 of normal play 1501 relate to Table ID 0×80. A portion 2401 of normal play 1501 relates to Table ID 0×81. At a point of time 2403, ECM A (CW A) is sent.

The last normal play ECM is now ECM C. The first ECM sent by the trick-play generator is ECM A, which has the same table ID. So it will not be processed although its content is needed to avoid an interruption of the trick-play stream.

Thus, the only situation that may cause problems is, when switching from normal play 1501 to reverse trick-play 1502 for stream type II, if the switching moment is in the predetermined time interval before the end of a period. This can be detected by looking at the toggles of the table ID and SCB in the normal play stream. This special situation may be present at the end of the period after the toggle of the table ID is reached but before the toggle in the SCB that indicates the start of the next period.

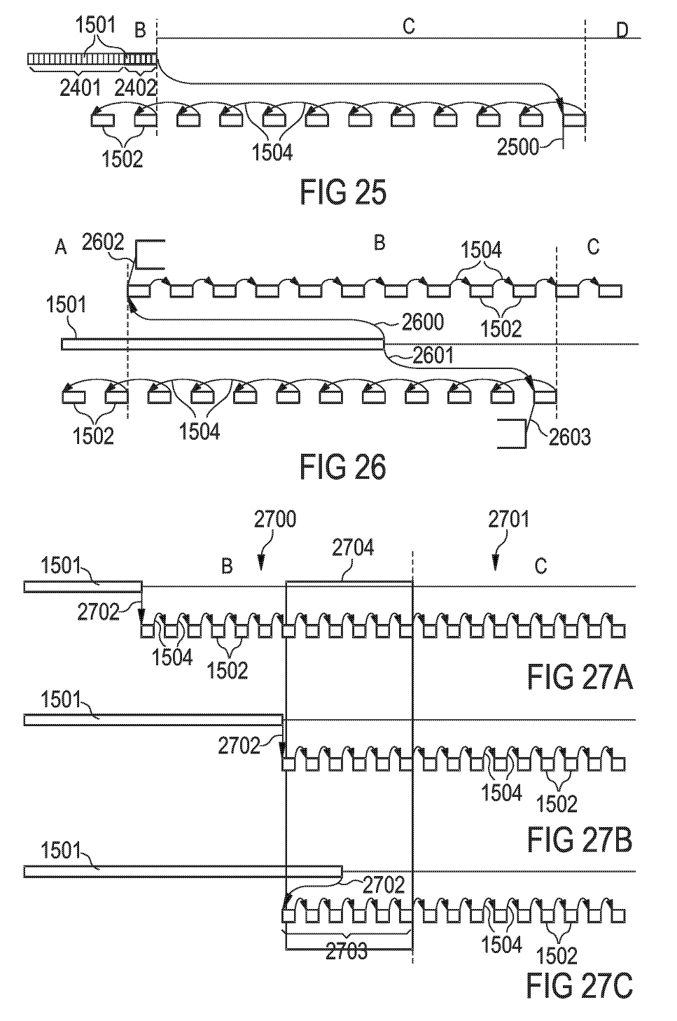

The problem can easily be solved. Normal play 1501 will just be continued in this case until the next period is reached. This is depicted in FIG. 25. At a point of time 2500, an ECM B (CW B) is sent.

The correct sequence of ECMs has already been checked. Further, availability of the smartcard has to be ensured. If it is busy with the processing of an ECM, it cannot receive and start the processing of a new ECM. This ECM might then be lost and therefore such situation should be avoided. Checking all the situations again reveals that this problem only occurs for stream type I reverse at the beginning of a period. In this case, normal play is continued until the smartcard is available again.

FIG. 26 illustrates “generalized fast switching” as follows:

If necessary, normal play 1501 will be continued until a valid switching point is reached. Then, the trick-play processing is started immediately. This trick-play may be initiated by switching to a fast forward mode 2600 or by switching to a fast reverse mode 2601. In the following, reference numeral 2600 may denote not only a point of time at which switching to a fast forward mode occurs, but may also be used to denote the fast forward mode. Accordingly, reference numeral 2601 may denote not only a point of time at which switching to a fast reverse node occurs, but may also be used to denote the fast reverse mode.

In case of switching to the fast forward mode 2600, an ECM B (stream type I) or an ECM C (stream type II) will be sent at a point of time 2602.

In case of a switching to the fast reverse mode 2601, an ECM B (CW B) will be sent at a point of time 2603.

The first trick-play block is read from the start (forward) or end (reverse) of the current period. The trick-play generator assumes that the current period was just entered and sends an ECM accordingly.

This fast switching method may not only be used in the case of a common decrypter but also if receiver and trick-play generator are in separate boxes with individual decrypters. Although the trick-play system is idle during normal play 1501, sending the ECMs of the normal play stream also to the trick-play system synchronizes its decrypter, thus enabling the fast switching. For this purpose, an ECM extractor connected to the transport stream input and an ECM switch is added to the trick-play generator in FIG. 14.

In the following, several aspects concerning optimisation of the jump target when switching or jumping between a first reproduction mode (for instance normal play) and a second reproduction mode (for instance trick-play) according to an exemplary embodiment of the invention will be described.

It was indicated that it may be best to start trick-play processing at the start (forward) or at the end (reverse) of the current period or segment. This will guarantee that the ECM sent at this same instant can be processed by the smartcard in time even at the highest trick-play speed given by the maximum throughput of the smartcard. At lower speeds however, the trick-play processing could be start at a position closer to the last normal play position. Thus, an optimised version of this method may be not to jump to the start or end of the current period but to a position in this period that depends on the trick-play speed. This position may then be such that it is guaranteed that the ECM of the next or previous period is decrypted before this period is entered. If the last normal play position is within the allowed range, it may be used as jump target. Otherwise, a position as close to it as possible might be chosen.

Such a situation is depicted in FIG. 27A to FIG. 27C for three different switching points to forward trick-play.

In the following, the three situations of jumping between a normal play mode 1501 and a trick-play 1502 will be described referring to FIG. 27A to FIG. 27C.

FIG. 27A shows a first situation in which a data stream's first segment 2700, namely a period B, and a second segment 2701, namely a period C, are shown. The border between the first segment 2700 and the second segment 2701 is denoted with reference numeral 2704. In each of FIG. 27A to FIG. 27C, a point of time 2702 is shown at which a user operates a user interface in such a manner as to perform a switch from the normal play mode 1501 into the trick-play mode 1502. Also depicted in FIG. 27A to FIG. 27C is a smartcard delay time 2703, that is to say a time that a smartcard needs for retrieving control words from an ECM.

In the scenario shown in FIG. 27A, the switch to the trick-play mode 1502 occurs at a relatively early point of time 2702 within period B, so that there is still enough time left to decrypt the ECM, since the remaining time in the first period 2700 is larger than the smartcard delay time 2703. Consequently, the trick-play mode 1502 starts immediately after a corresponding switching command of a user. There is no need to process a new ECM because the CW needed to decrypt the data in section 2700 is already present. Furthermore there is enough time available to process the next ECM to obtain the CW needed in section 2701. FIG. 27B shows a second scenario which is in some sense a kind of borderline scenario. In this scenario, the point of time 2702 is selected by a user in such a manner that it essentially coincides with a time interval 2703 before the border 2704. Here, it is still possible to immediately switch into a trick-play mode (in a “vertical” manner, see FIG. 27B), since the remaining time in the first segment 2700 is just sufficient to decrypt the subsequent ECM for decrypting data of the second segment 2701.

However, FIG. 27C shows a third situation, in which the user selects a switch from the normal play 1501 to the trick-play 1502 so late, that the remaining time interval of the first segment 2700 is not sufficient to decrypt the ECM for the subsequent segment 2701 before entering the subsequent segment 2701. In the scenario as shown in FIG. 27C, if the system would switch to the trick-play in a “vertical” manner as shown in FIG. 27A, 27B, there would be problems in the border region 2704. Therefore, the system jumps back to such a portion within the first segment 2700 that the time is sufficient to decrypt the ECM of the second segment 2701 taking into account the smartcard delay 2703. In other words, a portion of the first segment 2700 which has previously been replayed in normal mode 1501 will now again be replayed in trick-play mode 1502.

Although the jump is not necessarily to the start or end of the current period, it still has to be assumed that this period has just been entered and send an ECM accordingly.

However, there may be a complicating factor with the described method. Normally, the time position of packets in the recording is not used, but the latency of the smartcard is a time delay. So at least an adequate guess of the timing within a cryptographic period should be used.

In the following, it will be investigated how the data is read in trick-play. The time to read a data block from the storage device is often unknown because the data is read at a higher than real-time speed. The actual speed may depend on the storage device and the activities that it performs more or less simultaneously. What may be known however in the system is the time distance between the starts of reading subsequent blocks, because this is equal to the time of a trick-play GOP. This time t depends on the trick-play GOP size in frames T and the frame rate R and is given by:

t=T/R (5)

What can be concluded is that the number of these time distances n needed to compensate for the smartcard latency L should comply with the following formula:

n*t≧L (6)

One can only be sure about the timing, if n is an integer number. This results in:

n=int{L/t}+1 (7)

Assuming T=3 (IPP) and R=25 Hz results in t=120 ms. Assuming a largest reasonable latency L of around 800 ms results in n=7. It could of course be tried to monitor the latency of the smartcard and use this in the calculation, but otherwise an educated guess may be made on the safe side.

The distance between subsequent jump targets may be calculated in bytes D_{B} or in packets D_{P} as a function of the trick-play speed. This means that n*t seconds are equivalent to a distance of n*D_{B} bytes or n*D_{P} packets.

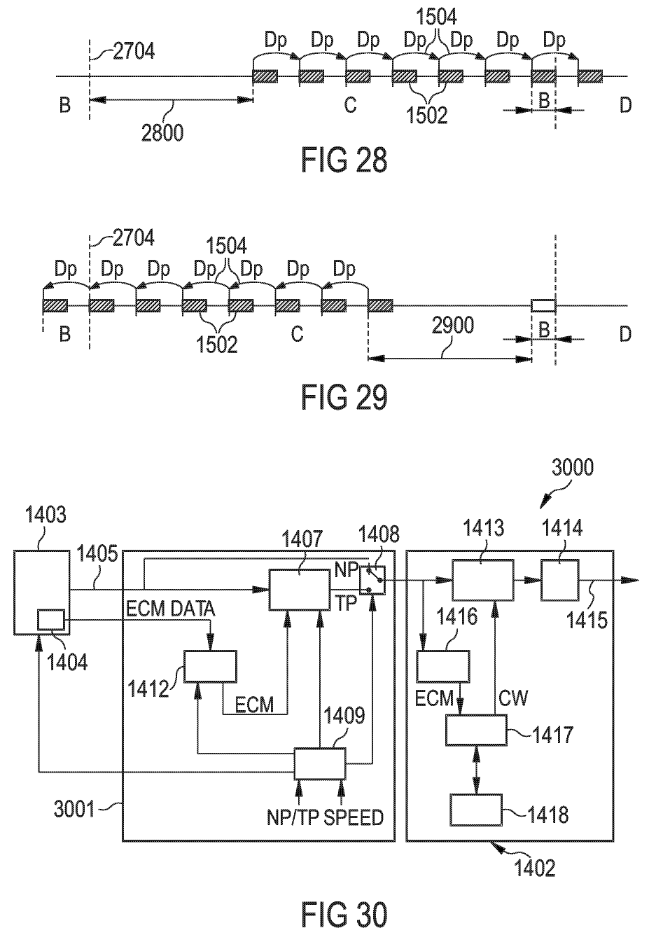

From FIG. 28, for forward trick-play, it can be seen that the minimum distance of the jump target to the end of the current period should be (n−1)*D_{P}+B packets, in which B is the block size in packets. The resulting value might sometimes be larger than the period size due to the rounding to the nearest higher integer n and an overestimated latency L. In this case, the jump target is equal to the start of the current period. Otherwise, the jump target is between the start of the current period and the calculated point, as close as possible to the last normal play position. An allowed start region 2800 is illustrated in FIG. 28.

From FIG. 29 for reverse trick-play, it can be seen that the minimum distance of the jump target to the start of the current period should be (n−1)*D_{P} packets. Again, this value might be larger than the period size in which case no optimisation is possible. The jump target is then one block before the end of the current period. Otherwise the jump target is chosen between the calculated position and a position one block before the end of the current period, as close as possible to the last normal play position. An allowed start region 2900 is illustrated in FIG. 29.

As a further refinement, it is possible to enlarge the allowed start region by choosing a smaller D_{P} value for the current period and then switch to the nominal D_{P} value when the next period is entered. Smaller D_{P} values result in lower trick-play speeds. So it is possible to start with a lower trick-play speed if necessary and then switching to the desired speed is possible at the crossing to the next period. This may result in an even better matching between the trick-play start position and the current normal play position.

In the following, several further aspects related to switching from normal play to trick-play and vice versa will be explained.

Several system configurations are possible in the case of hybrid streams. Hybrid data streams may particularly denote streams with a mixture of encrypted and non-encrypted portions. The configuration of FIG. 14 is also applicable in the case that the hybrid stream is constructed at the playback side of the storage device.

Usually, only a hybrid trick-play stream would be generated. The generation of a hybrid normal play stream at the playback side of the storage device 1403 would also be possible with a somewhat different configuration. In this case, the transport stream 1405 will always be fed through the trick-play stream construction unit 1407 that then also generates a hybrid normal play stream.

For the situation with a recorded hybrid stream, the configuration is somewhat different, as is depicted in FIG. 30.

FIG. 30 shows a modified system 3000 in a configuration for a hybrid stream. The system 3000 includes a trick-play generator 3001 and a receiver 1402. The latter may be constituted similar as in FIG. 14.

No decryption is needed in the trick-play generator 3001 in this case. ECM insertion is however performed to enable the decryption of the trick-play stream in the receiver 1402. In any case it is clear that the decrypter 1413 in the receiver 1402 will decrypt both, that is the normal play and the trick-play stream. In one configuration, there is an additional decrypter in the trick-play generator 3001. Both decrypters may be automatically synchronized by the use of the same ECMs at the same relative moment.

For switching from normal play to trick-play, actions for receiver 1402 and trick-play generator 3001 may be reversed, because the decryption of the trick-play stream takes place in the receiver 1402 now. Moreover, it is clear that there is a common decrypter for trick-play and normal play (in the receiver 1402), and possibly an additional synchronized decrypter for trick-play in the trick-play generator 3001. This configuration is identical to the fast switching situation described above. Also the optimisation of the jump target is valid here. So reference is made to the corresponding above parts of this description. The switching method for a hybrid stream is identical to what is described there.

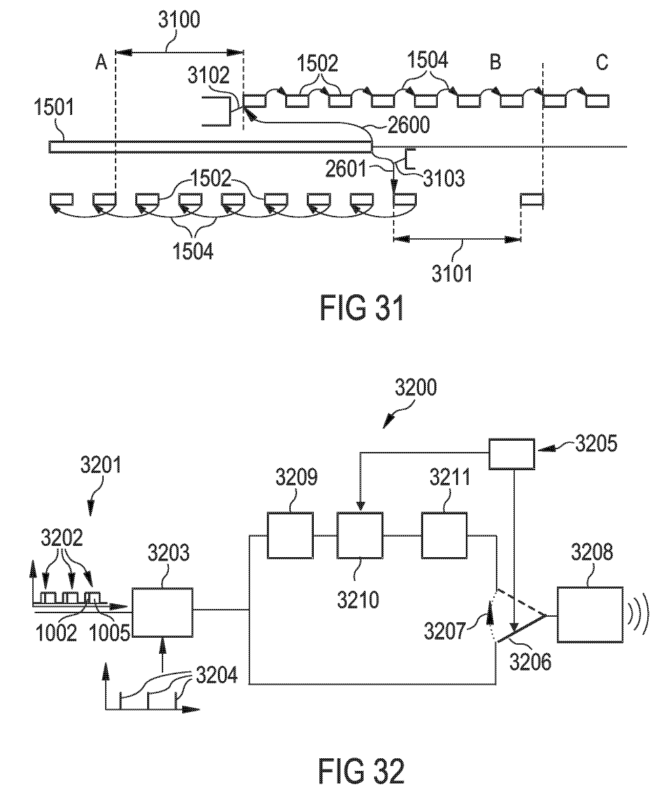

Referring to FIG. 31, normal play 1501 will be continued until an appropriate switching point is reached. Then, the trick-play processing is started. This trick-play 1502 may be a fast forward mode 2600 or a fast reverse mode 2601. In case of a fast forward mode 2600, an ECM B (stream type I) or an ECM C (stream type II) will be sent at a point of time 3102. In case of a fast reverse mode 2601, an ECM A will be sent at a point of time 3103. A corresponding allowed start region is denoted with reference numerals 3100 and 3101.

The switching from normal play to trick-play as depicted in FIG. 31 may be as follows:

If necessary, continue normal play 1501 until a valid switching point is reached;

Then the trick-play processing is started immediately. The first trick-play block is read from the start (forward) or end (reverse) of the current period or at least from a starting position inside the allowed start region;

The trick-play generator assumes that the current period was just entered and sends an ECM accordingly.

In the following, referring to FIG. 32, a device 3200 for processing an encrypted data stream 3201 in a cryptographic system according to an exemplary embodiment of the invention will be described.

As can be taken from FIG. 32, an encrypted data stream 3201 comprising a plurality of segments 3202 is provided to an input of a decrypting unit 3203. Each of the segments 3202 comprises a header unit 1002 and a payload unit 1005. Control words 3204 are provided to the decrypter 3203 which allows to decrypt encrypted portions of the segments 3202. Thus, at the output of the decrypter 3203, a decrypted data stream is provided.

Further, a user interface 3205 is provided via which a user may provide the system 3200 with control commands to process data selectively in a normal reproduction mode or in a trick-play mode. By these control commands, a switch 3206 is controlled between a first switch position (see FIG. 32) and a second switch position (not shown) which can be obtained by switching the switch 3206 along an arrow 3207.

When the switch 3206 is in the position shown in FIG. 32, the data decrypted by the decrypter 3203 are directly provided to a reproduction unit 3208 (for instance a display for displaying visual information and/or a loudspeaker for reproducing audible information).

However, when the user operates the user interface 3205 (for instance a button) in a manner to set the second switch position not shown in FIG. 32, a trick-play mode will be initiated, as will be explained in the following.

A first determining unit 3209 is provided in the trick-play mode signal path for determining, in case of switching from the normal reproduction mode to the trick-play reproduction mode, a current position of reproduction within the data stream. Further, a second determining unit 3210 (which may optionally be controlled by a user via the user interface 3205) is provided for determining a starting position for starting reproduction in a second reproduction mode based on the determined current position supplied by the first determining unit 3209. For determining a starting position, the second determining unit 3210 takes into accounts characteristics of the cryptographic system. Particularly, the starting position is determined based on a delay with which the control words 3204 for decrypting different segments 3202 of the encrypted data stream 3201 are provided in the cryptographic system.

Furthermore, a trick-play generation unit 3211 is provided for reproduction in the trick-play mode from the starting position onwards.

According to FIG. 32, the switch 3206 is provided at the end of the chain, that is to say after units 3209 to 3211, so that the determining units 3209, 3210 can perform their determining tasks continuously in order to switch as fast as possible without interrupting the output stream to the reproduction unit 3208.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1-18. (canceled)

19. A device (3200) for processing an encrypted data stream (3201) in a cryptographic system, in which decryption data (3204) are provided for decrypting each segment (3202) of the encrypted data stream (3201) for reproduction of the decrypted data stream,
wherein the device (3200) comprises
a first determining unit (3209) for determining, in case of switching from a first reproduction mode (1501) of reproducing the data stream (3201) to a second reproduction mode (1502) of reproducing the data stream (3201), a current position of reproduction within the data stream (3201);
a second determining unit (3210) for determining a starting position for starting reproduction in the second reproduction mode (1502) based on the determined current position, and wherein the second determining unit (3210) is adapted for determining a starting position for starting reproduction in the second reproduction mode (1502) based on a delay (2703) with which decryption data (3204) are provided in the cryptographic system.

20. The device (3200) according to claim 19,
wherein the second determining unit (3210) is adapted for determining a starting position for starting reproduction in the second reproduction mode (1502) based on characteristics of the cryptographic system.

21. The device (3200) according to claim 19,
wherein the second determining unit (3210) is adapted for determining a starting position for starting reproduction in the second reproduction mode (1502) based on a delay (2703) with which decryption data (3204) for decrypting a succeeding segment are provided in the cryptographic system.

22. The device (3200) according to claim 19,
wherein the second determining unit (3210) is adapted for determining a beginning or an end of a segment preceding or succeeding the currently reproduced segment as a starting position for starting reproduction in the second reproduction mode (1502).

23. The device (3200) according to claim 19,
wherein the second determining unit (3210) is adapted to determine the starting position based on a speed of reproduction of the data stream (3201) according to the second reproduction mode (1502).

24. The device (3200) according to claim 19,
wherein the second determining unit (3210) is adapted to determine the starting position in such a manner that a segment of the encrypted data stream (3201) which is to be reproduced next after a currently reproduced segment of the data stream is decryptable by means of the corresponding decryption data (3204) decrypted at a time before the reproduction of the currently reproduced segment of the data stream (3201) is finished.

25. The device (3200) according to claim 19,
adapted to process an encrypted data stream (3201) of video data or audio data.

26. The device (3200) according to claim 19,
adapted to process an encrypted data stream (3201) of digital data.

27. The device (3200) according to claim 19,
wherein the first reproduction mode is a normal reproduction mode (1501).

28. The device (3200) according to claim 19,
wherein the second reproduction mode is a trick-play reproduction mode (1502).

29. The device (3200) according to claim 28,
wherein the trick-play reproduction mode (1502) is one of the group consisting of a fast forward reproduction mode (2600), a fast reverse reproduction mode (2601), a slow motion reproduction mode, a freeze frame reproduction mode, an instant replay reproduction mode, and a reverse reproduction mode.

30. The device (3200) according to claim 19,
comprising a generation unit (3211) adapted to generate a decrypted data stream or an encrypted data stream for reproduction in the second reproduction mode (1502) from the starting position onwards.

31. The device (3200) according to claim 19,
adapted to process an encrypted MPEG2 data stream.

32. The device (3200) according to claim 19,
realized as at least one of the group consisting of a digital video recording device and a network-enabled device and a conditional access system and a portable audio player and a portable video player and a mobile phone and a DVD player and a CD player a harddisk-based media player and an internet radio device and a public entertainment device and an MP3 player.

33. A method of processing an encrypted data stream (3201) in a cryptographic system, in which decryption data (3204) are provided for decrypting each segment (3202) of the encrypted data stream (3201) for reproduction of the decrypted data stream,
wherein the method comprises the steps of
in case of switching from a first reproduction mode (1501) of reproducing the data stream (3201) to a second reproduction mode (1502) of reproducing the data stream (3201), determining a current position of reproduction within the data stream (3201);
determining a starting position for starting reproduction in the second reproduction mode (1502) based on the determined current position and a delay (2703) with which decryption data (3204) are provided in the cryptographic system.

34. A computer-readable medium, in which a computer program of processing an encrypted data stream (3201) in a cryptographic system, in which decryption data (3204) are provided for decrypting each segment (3202) of the encrypted data stream (3201) for reproduction of the decrypted data stream (3201), is stored, which computer program, when being executed by a processor, is adapted to control or carry out the following method steps:
in case of switching from a first reproduction mode (1501) of reproducing the data stream (3201) to a second reproduction mode (1502) of reproducing the data stream, determining a current position of reproduction within the data stream (3201);
determining a starting position for starting reproduction in the second reproduction mode (1502) based on the determined current position and a delay (2703) with which decryption data (3204) are provided in the cryptographic system.

35. A program element of processing an encrypted data stream (3201) in a cryptographic system, in which decryption data (3204) are provided for decrypting each segment (3202) of the encrypted data stream (3201) for reproduction of the decrypted data stream, which program element, when being executed by a processor, is adapted to control or carry out the method steps of:
in case of switching from a first reproduction mode (1501) of reproducing the data stream (3201) to a second reproduction mode (1502) of reproducing the data stream (3201), determining a current position of reproduction within the data stream (3201);
determining a starting position for starting reproduction in the second reproduction mode (1502) based on the determined current position and a delay (2703) with which decryption data (3204) are provided in the cryptographic system.
